(19) United States
(12) Patent Application Publication
(10) Pub. No.: US 2018/0208775 A1
(43) Pub. Date: Jul. 26, 2018

(54) NEW AROMATIC MACROCYCLIC METAL COMPLEX DYES AND THE SYNTHESIS THEREOF WITH ACTIVE NANO METAL POWDERS

(71) Applicants: Ugursoy OLGUN, Adapazan (TR); Salih Zeki YILDIZ, Adapazan (TR)

(72) Inventors: Ugursoy OLGUN, Adapazan (TR); Salih Zeki YILDIZ, Adapazan (TR)

(21) Appl. No.: 15/321,690

(22) PCT Filed: Dec. 30, 2014
(86) PCT No.: PCT/TR2014/000525

§ 371 Date: Dec. 22, 2016

(30) Foreign Application Priority Data
Jun. 23, 2014 (TR) 2014/07271

(51) Int. Cl. C09B 47/04

(52) U.S. Cl. CPC C09B 47/04

(57) ABSTRACT

The present invention relates to a new type of inorganic coordination compound dyes having advanced technology optical, electronic and medical characteristics and relates to production of these dyes by means of new synthesis methods. The present invention relates to dyes which are metal (M: Li, Na, K, Mg, Ca, Sr, Ba, Ti, Zr, V, Cr, Mo, Mn, Re, Fe, Ru, Co, Rh, Ir, Ni, Pd, Pt, Cu, Ag, Au, Zn, Cd, B, Al, Ga, In, Si, Ge, Sn, Pb, Sb, Bi, Se, Te) complexes of aromatic macrocyclic compounds of the type Phtalocyanine (Pc), Naphtalocyanine (Nc), Porphyrazine (Pz), Porphyrin (Pr), sub-Phtalocyanine (subPc), sub-Naphtalocyanine (subNc), sub-Porphyrazine (subPz), sub-Porphyrine (subPr), and relates to the synthesis of these complexes and derivatives. The subject matter dyes can be used in solar cell photovoltaic (PV) panels, in OLEDS which are organic structured light emitting diodes, in polymers, in textile and in photodynamic therapy PDT applications. Moreover, industrial applications are possible which depend on strong fluorescence characteristics.

### TECHNICAL FIELD

The present invention relates to a new type of inorganic coordination compound dyes having advanced technology optical, electronic and medical characteristics, and relates to production of these dyes by means of new synthesis methods. The present invention relates to dyes which are metal (M: Li, Na, K, Mg, Ca, Sr, Ba, Ti, Zr, V, Cr, Mo, Mn, Re, Fe, Ru, Co, Rh, Ir, Ni, Pd, Pt, Cu, Ag, Au, Zn, Cd, B, Al, Ga, In, Si, Ge, Sn, Pb, Sb, Bi, Se, Te) complexes of aromatic macrocyclic compounds of the type Phtalocyanine (Pc), Naphtalocyanine (Nc), Porphyrazine (Pz), Porphyrine (Pr), sub-Phtalocyanine (subPc), sub-Naphtalocyanine (subNc), sub-Porphyrazine (subPz), sub-Porphyrine (subPr), and relates to the synthesis of these complexes and their derivatives. The subject matter dyes can be used in solar cell photovoltaic (PV) panels, in OLEDs which are organic structured light emitting diodes, in polymers, in textile and in photodynamic therapy PDT applications. Moreover, the industrial applications thereof are possible which depend on strong fluorescence characteristics.

### PRIOR ART

In the production of dyes which are metal complexes of aromatic macrocyclic compounds like Phtalocyanine (Pc), Naphtalocyanine (Nc), Porphyrazine (Pz), Porphyrine (Pr), sub-Phtalocyanine (subPc), sub-Naphtalocyanine (subNc), sub-Porphyrazine (subPz), sub-Porphyrine (subPr), old methods are used which are based on direct usage of metals or metal salts. Some disadvantages of these methods are low reaction efficiencies, high reaction temperatures and long reaction durations.

When the known state of the art is examined, the studies regarding the synthesis of various fluorescence complexes including boron become important in the recent years because of the applications in the energy field. Different methods are used in the synthesis of boron complexes. Synthesis method and conditions are determined in accordance with the targeted molecule structure. In the subject matter invention, particularly intensive studies have been made about new synthesis methods which have low cost, whose reaction efficiency is high and which may have a commercial potential in practice. In the scientific studies realized recently, it is known that the dyes with type Boron sub-Phtalocyanine (BsubPc) increase the photo-voltaic (OPV) solar cell efficiency substantially, and increase the OLED light emission efficiency.

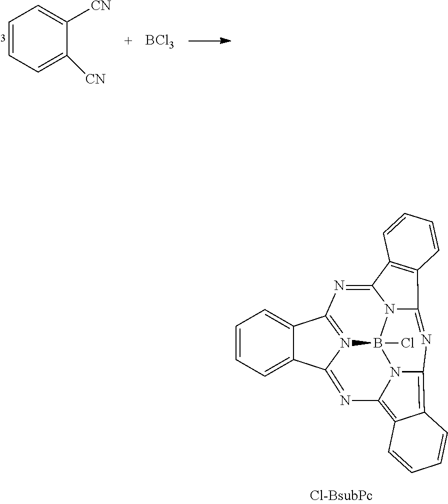

The frequently known synthesis and molecule structure of Cl-BsubPc, which is the commercially produced boron sub-phtalocyanine chlorine derivative, has been illustrated above. In the known state of the art, in the synthesis of (Cl-BsubPc) which is chlorine derivative of boron sub-phtalocyanine, the solution of BCl₃ gas in a solvent like heptane, toluene is added to a reaction medium comprising phthalonitrile, and the solvent is distillated during the reaction and it is removed from the medium. The usage of the BCl₃ gas is not convenient for practical synthesis and it is relatively complex. Moreover, some nitrile derivatives (for instance, some structures comprising ether-bound and allyl groups) are deteriorated in strong acidic BCl₃ conditions, and it is not possible to prepare the subPc compounds of them. Moreover, the synthesis of sub-phtalocyanine compounds with the metal types other than boron is not known.

### BRIEF DESCRIPTION OF THE INVENTION

The present invention relates to inorganic coordination compound dyes and relates to the production thereof by means of synthesis methods which have been recently developed. The present invention relates to dyes which are metal (M: Li, Na, K, Mg, Ca, Sr, Ba, Ti, Zr, V, Cr, Mo, Mn, Re, Fe, Ru, Co, Rh, Ir, Ni, Pd, Pt, Cu, Ag, Au, Zn, Cd, B, Al, Ga, In, Si, Ge, Sn, Pb, Sb, Bi, Se, Te) complexes of aromatic macrocyclic compounds of the type Phtalocyanine (Pc), Naphtalocyanine (Nc), Porphyrazine (Pz), Porphyrine (Pr), sub-Phtalocyanine (subPc), sub-Naphtalocyanine (subNc), sub-Porphyrazine (subPz), sub-Porphyrine (subPr), and relates to the synthesis of the new derivatives of these complexes.

The developed synthetic method eliminates the usage of BCl₃ or BBr₃ gases, and provides production of BsubPc derivative dyes directly from Boron powder under chemically lighter conditions. In a similar manner, it is also possible to synthesize BsubNc derivative dyes directly from boron powder.

In addition to the abovementioned general advantages, some other important advantages which are specific to the related metal have been given below.

The BsubPc complex formed by sub-phtalocyanine (subPc) dyes only with the boron element and the different derivatives thereof are known. Up to now, a new subPc dye could not be made with the other metals. The subject matter method provides preparation of subPc complexes from different metals (M1). Again, the BsubNc complex made by subNc dyes only with the boron element and the different derivatives thereof are known. Up to now, a new subNc dye could not be made with the other metals. The subject matter method provides subNc compounds of different metals (M₁) to be prepared.

The subject matter method provides synthesis of subPc and Pc compounds with different metals like Li, Na, K, Mg, Ca, Sr, Ba, Ti, Zr, V, Cr, Mo, Mn, Re, Fe, Ru, Co, Rh, Ir, Ni, Pd, Pt, Cu, Ag, Au, Zn, Cd, B, Al, Ga, In, Si, Ge, Sn, Pb, Sb, Bi, Se, Te.

The subject matter method provides synthesis of subNc and Nc compounds with other metals like Li, Na, K, Mg, Ca, Sr, Ba, Ti, Zr, V, Cr, Mo, Mn, Re, Fe, Ru, Co, Rh, Ir, Ni, Pd, Pt, Cu, Ag, Au, Zn, Cd, B, AI, Ga, In, Si, Ge, Sn, Pb, Sb, Bi, Se, Te.

The subject matter method provides preparation of subPz and Pz dyes of different metals like Li, Na, K, Mg, Ca, Sr, Ba, Ti, Zr, V, Cr, Mo, Mn, Re, Fe, Ru, Co, Rh, Ir, Ni, Pd, Pt, Cu, Ag, Au, Zn, Cd, B, Al, Ga, In, Si, Ge, Sn, Pb, Sb, Bi, Se, Te.

The subject matter method provides preparation of subPr and Pr dyes of different metals like Li, Na, K, Mg, Ca, Sr, Ba, Ti, Zr, V, Cr, Mo, Mn, Re, Fe, Ru, Co, Rh, Ir, Ni, Pd, Pt, Cu, Ag, Au, Zn, Cd, B, Al, Ga, In, Si, Ge, Sn, Pb, Sb, Bi, Se, Te.

By means of the subject matter method, product selectivity can be provided in accordance with the mole proportions of the beginning substances, reaction solvent, temperature and duration.

The subject matter method provides synthesis of Pc dyes with and without metal by means of the ring expansion of the subPc's.

By means of the subject matter method, the groups, provided at the center of the subPc and subNc's and subPz and subPr's and bound axially to metal, can be changed. The groups which can be bound axially are primarily R—OH, R—NH₂, R—SH, R—COOH, R—SO₃H, R—B(OH)₂, Ar—OH, Ar—NH₂, Ar—SH, Ar—COOH, Ar—B(OH)₂, Ar—SO₃H, H₂O, F⁻, Cl⁻, Br⁻, I⁻, CN⁻, NO₃⁻, H₃BO₃, H₃PO₄ and the different derivatives of them.

By means of the subject matter method, different phthalonitrile, naphthalonitrile, isoindoline and dicyanoimidazole derivatives are used, and new types of dyes can be synthesized by means of different metals.

The subject matter method provides production of complex dyes whose solubility and dispersion are increased. Complex dyes make absorption within a wider range in the visible region.

The dyes produced by means of the subject matter method can be widely used in industry such as:

1. in photo-voltaic (PV) panels having solar cell,
2. in OLEDs which are light emitting organic diodes,
3. in treatments necessitating photodynamic therapy (PDT),
4. in bleaching, coloring and molecular marking applications as strong fluorescence dye,
5. in antibacterial formulations,
6. in touch-screens, in production of DVDs,
7. in optical filters, in light absorbing, semi-conductor dye, electron emitting and electron receiving layers,
8. in anti-symmetric Pc, Nc and Pz syntheses,
9. in textile, polymer and detergent sectors.

In order to realize the abovementioned objects and the objects which are to be deducted from the detailed description below, the present invention is the aromatic macrocyclic metal complex having Formula (I), wherein the aromatic macrocyclic compound is selected from a group comprising Phtalocyanine (Pc), Naphtalocyanine (Nc), Porphyrazine (Pz), Porphyrine (Pr), sub-Phtalocyanine (subPc), sub-Naphtalocyanine (subNc), sub-Porphyrazine (subPz), sub-Porphyrine (Pr), and the metal is selected from a group comprising Li, Na, K, Mg, Ca, Sr, Ba, Ti, Zr, V, Cr, Mo, Mn, Re, Fe, Ru, Co, Rh, Ir, Ni, Pd, Pt, Cu, Ag, Au, Zn, Cd, B, Al, Ga, In, Si, Ge, Sn, Pb, Sb, Bi, Se, Te elements.

In a preferred embodiment of the present invention, it is an aromatic macrocyclic metal complex and it is dea-BsubPc.

In another preferred embodiment of the present invention, it is an aromatic macrocyclic metal complex and it is dea-BsubNc.

In another preferred embodiment of the present invention, it is an aromatic macrocyclic metal complex and it is ZnsubPz.

In another preferred embodiment of the present invention, it is an aromatic macrocyclic metal complex and it is TisubPz.

In another preferred embodiment of the present invention, it is an aromatic macrocyclic metal complex and it is MgsubPz.

In another preferred embodiment of the present invention, it is an aromatic macrocyclic metal complex and it is AlsubPz.

In another preferred embodiment of the present invention, they are the dimers of aromatic macrocyclic metal complexes.

In another preferred embodiment of the present invention, it is dimer aromatic macrocyclic metal complex and it is dmae₂-Zn₂(subPc)₂.

In another preferred embodiment of the present invention, it is aromatic macrocyclic metal complex and it is Zn₂(subNc)₂.

In another preferred embodiment of the present invention, they are the acid salts of an aromatic macrocyclic metal sub-phtalocyanine complex or the dimer thereof, wherein they are acetic acid or Trifluoroacetic acid and other organic carbocyclic acid or sulfonic acid derivatives.

In another preferred embodiment of the present invention, it is a dimer metal sub-phtalocyanine complex, and it is (CH₃COO)₂—Zn₂(subPc)₂.

In another preferred embodiment of the present invention, it is a dimer metal sub-phtalocyanine complex, and it is (CF₃COO)₂—Zn₂(subPc)₂.

In another preferred embodiment of the present invention, it is a dimer metal sub-phtalocyanine complex, and it is (CH₃COO)₂—Zn₂(subNc)₂.

In another preferred embodiment of the present invention, it is a dimer metal sub-phtalocyanine complex, and it is (CF₃COO)₂—Zn₂(subNc)₂.

In another preferred embodiment of the present invention, it is a method for synthesis of Formula (I), wherein nano metal powder is used. Preferably, nano metal powders are used which are prepared by means of the methods given in patent with application number 2014/06804. The below defined metal and metal oxide carrier catalysts and the MX co-catalysts are preferably added to the reaction medium.

The subject matter M metal catalyst is selected from Li, Na, K, Mg, Ca, Sr, Ba, Ti, Zr, V, Cr, Mo, Mn, Re, Fe, Ru, Co, Rh, Ir, Ni, Pd, Pt, Cu, Ag, Au, Zn, Cd, B, Al, Ga, In, Si, Ge, Sn, Pb, Sb, Bi, Se, Te.

The MO metal oxide catalysts used are selected from Al₂O₃, ZnO, TiO₂, SiO₂, MgO, B₂O₃, Zeolite and Hydroxyapatite.

In the MX co-catalysts used, the metal is the metal of the catalysts given above, and X is selected from F, Cl, Br, I, CH₃COO—, SO₄²—, C₂O₄²⁻, PO₄³⁻, NO₃⁻, OH⁻, CO₃²⁻, HCO₃⁻, H₂PO₄⁻, HPO₄²⁻.

In another preferred embodiment of the present invention, Formula (I) is the usage of compounds as a dye.

In another preferred embodiment of the present invention, it is a synthesis method wherein the solvent is selected from mono alcohols with high molecular weight, mono alcohols with low molecular weight, poly alcohols with high molecular weight, poly alcohols with low molecular weight, polyethylene glycols with low and high molecular weight, alkyl amines, mono ethanol amine, substituted mono ethanol amines, N,N-dimethyl ethanol amine (DMAE), diethanol amine (DEA), triethanol amine, ethylene diamine, substituted ethylene diamines, polyethylene amines, morpholine, piperazine, N-methyl prolidone, pyridine, substituted pyridines, N alkyl and N,N dialkyl amine substituted pyridines, the substances comprising pyrimidine rings, quinoline, urea, substituted urea, dimethyl urea, tetramethyl urea, aniline, substituted anilines, acetamide, substituted acetamides, formamide, substituted formamides and water. In addition to these; toluene, xylene, cumene, benzene, naphthalene, chlorobenzene, dichlorobenzene, chloroform, acetone, ethyl methyl ketone, methanol, ethanol, isopropanol, butanol, acetonitrile, ethyl acetate, dimethylformamide, dimethylsulphoxide, tetrahydrofuran are used in the reactions.

By means of the subject matter method, the groups axially bound to the metal, placed at the center of subPc and subNc and subPz and subPr, can be changed. The axially bound groups are primarily R—OH, R—NH₂, R—SH, R—COOH, R—SO₃H, R—B(OH)₂, Ar—OH, Ar—NH₂, Ar—SH, Ar—COOH, Ar—B(OH)₂, Ar—SO₃H, H₂O, F⁻, Cl⁻, Br⁻, I⁻, CN⁻, NO₃⁻, H₃BO₃, H₃PO₄ and the derivatives of them.

### BRIEF DESCRIPTION OF THE FIGURES

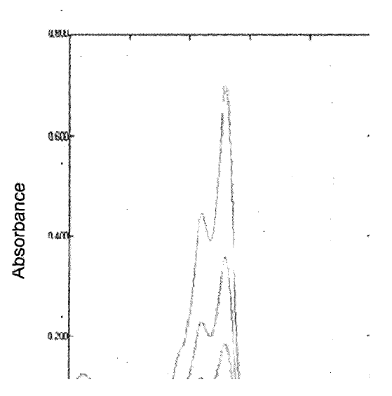

In FIG. 1, the UV-vis spectrum taken in (0.25-2)×10⁻⁴ M methanol solutions for the dea-BsuPc compound is given.

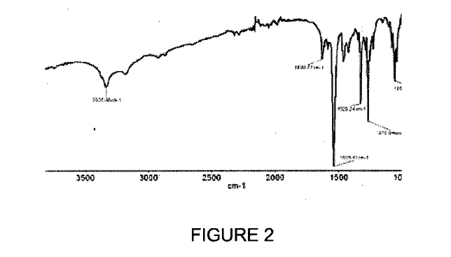

In FIG. 2, FT-IR spectrum of the dea-BsuPc compound is illustrated.

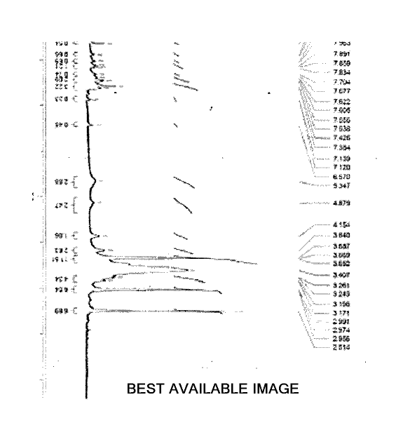

In FIG. 3, ¹H-NMR spectrum of the dea-BsubPc compound is illustrated.

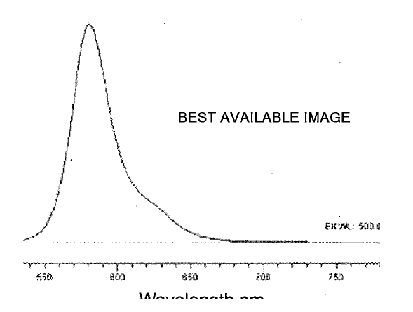

In FIG. 4, the fluorescence spectrum of methanol solution, excited at 500 nm, of the dea-BsubPc compound is illustrated.

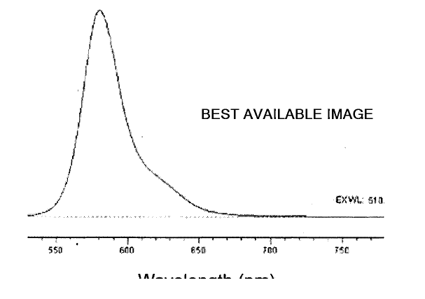

In FIG. 5, the fluorescence spectrum of methanol solution, excited at 510 nm, of the dea-BsubPc compound is illustrated.

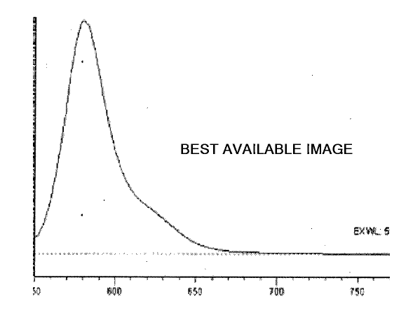

In FIG. 6, the fluorescence spectrum of methanol solution, excited at 561 nm, of the dea-BsubPc compound is illustrated.

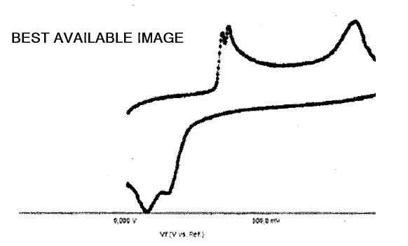

In FIG. 7, the electrochemical current-voltage (CV) curve of the methanol solution of the dea-BsubPc compound is illustrated.

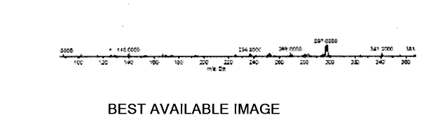

In FIG. 8, ESI-MS mass analysis results of the dea-BubPc compound is illustrated.

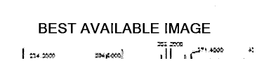

In FIG. 9, ESI-MS mass analysis results of the dea-BubPc compound is illustrated.

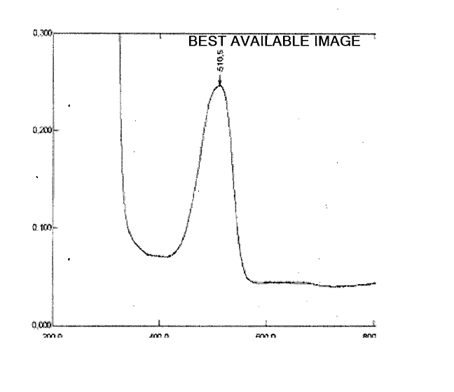

In FIG. 10, UV-vis spectrum of the dea-BsubNc compound is illustrated.

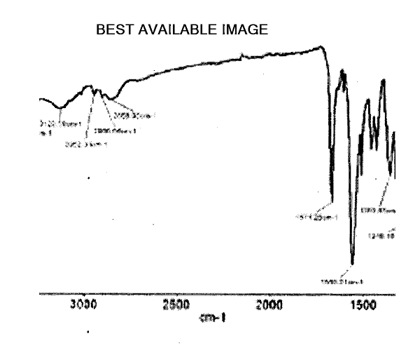

In FIG. 11, the FT-IR spectrum of the dea-BsubNc compound is illustrated.

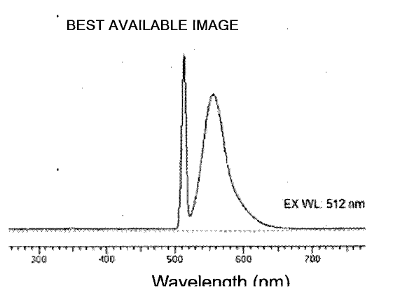

In FIG. 12, the fluorescence spectrum of the dea-BsubNc compound is illustrated.

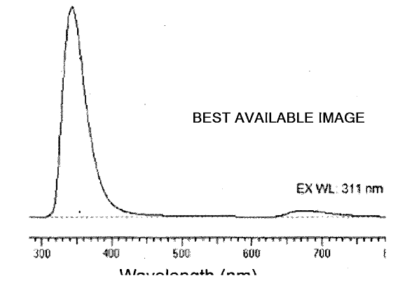

In FIG. 13, the fluorescence spectrum of the dea-BsubNc compound is illustrated.

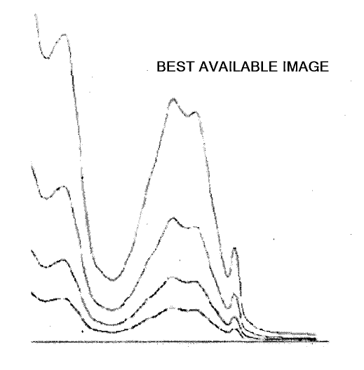

In FIG. 14, the UV-vis spectrums of dmae₂-Zn₂(subPc)₂ compound in (0.24-0.94)×10⁻⁴ M tetrahydrofuran are illustrated.

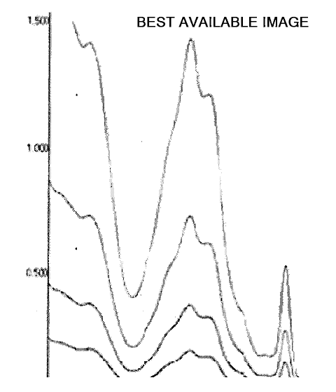

In FIG. 15, the UV-vis spectrums of dmae₂-Zn₂(subPc)₂ compound in (0.24-0.94)×10⁻⁴ M concentration range in tetrahydrofuran/CH₃COOH at a proportion of 50:1 are illustrated.

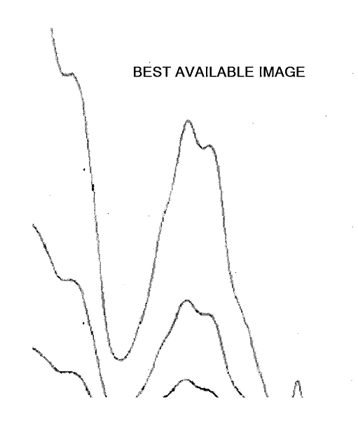

In FIG. 16, the UV-vis spectrums of dmae₂-Zn₂(subPc)₂ compound in (0.24-0.94)×10⁻⁴ M methanol are illustrated.

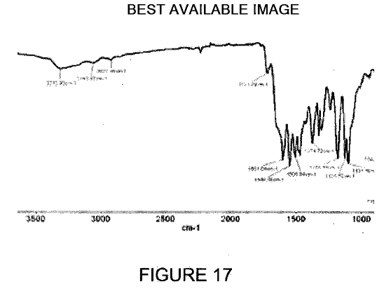

In FIG. 17, the FT-IR spectrum of dmae₂-Zn₂(subPc)₂ compound is illustrated.

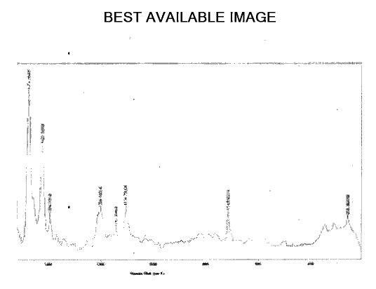

In FIG. 18, the Raman spectrum of dmae₂-Zn₂(subPc)₂ compound is illustrated.

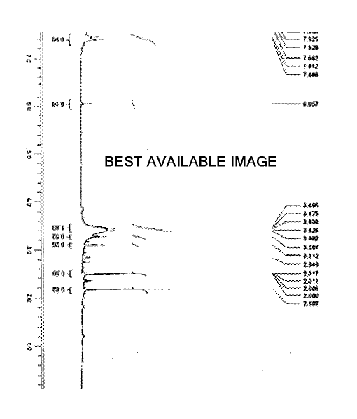

In FIG. 19, ¹H NMR spectrum of dmae₂-Zn₂(subPc)₂ compound is illustrated.

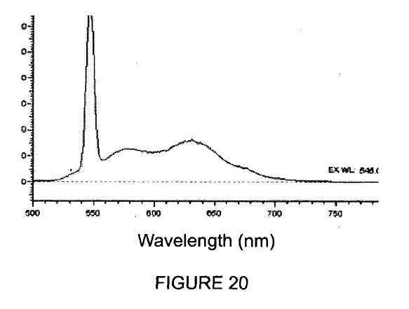

In FIG. 20, the fluorescence spectrum of dmae₂-Zn₂(subPc)₂ compound in 0.94×10⁻⁴ M concentration in tetrahydrofuran is illustrated.

In FIG. 21, the fluorescence spectrum of dmae₂-Zn₂(subPc)₂ compound in 0.94×10⁻⁴ M concentration in tetrahydrofuran/CH₃COOH, having proportion of 50:1, by means of 510 nm excitation is illustrated.

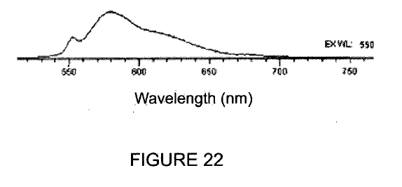

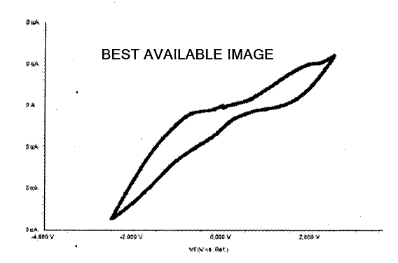

In FIG. 22, the fluorescence spectrum of dmae₂-Zn₂(subPc)₂ compound in 0.94×10⁻⁴ M concentration in tetrahydrofuran/CH₃COOH, having proportion of 50:1, by means of 550 nm excitation is illustrated.

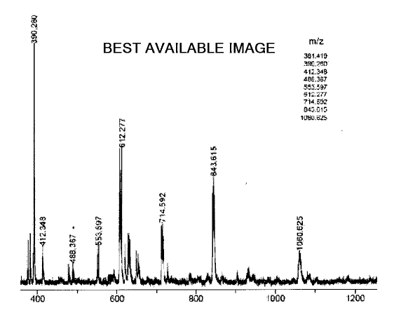

In FIG. 23, the electrochemical current-voltage (CV) curve of the dmae₂-Zn₂(subPc)₂ compound is illustrated.

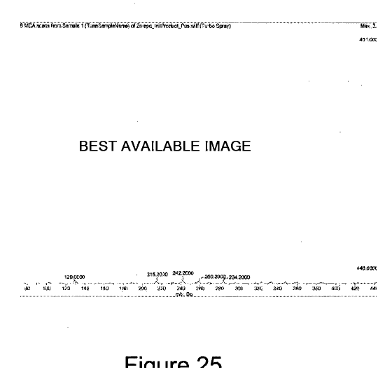

In FIG. 24, Maldi-Tof-MS mass spectrum of dmae₂-Zn₂(subPc)₂ compound is illustrated.

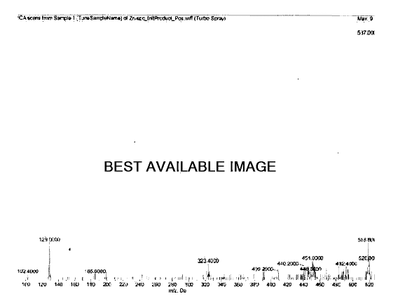

In FIG. 25, ESI-MS mass spectrum-1 of dmae₂-Zn₂(subPc)₂ compound is illustrated.

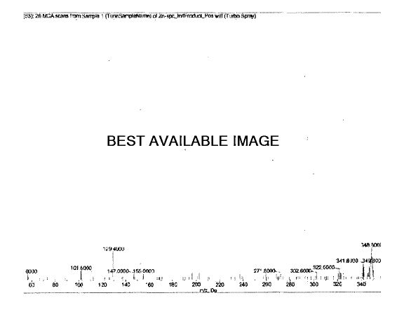

In FIG. 26, ESI-MS mass spectrum-2 of dmae₂-Zn₂(subPc)₂ compound is illustrated.

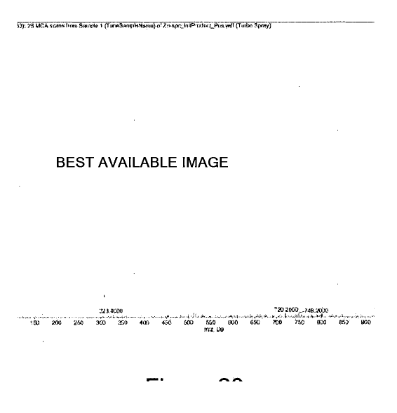

In FIG. 27, ESI-MS mass spectrum-3 of dmae₂-Zn₂(subPc)₂ compound is illustrated.

In FIG. 28, ESI-MS mass spectrum-4 of dmae₂-Zn₂(subPc)₂ compound is illustrated.

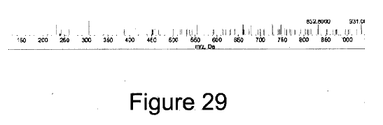

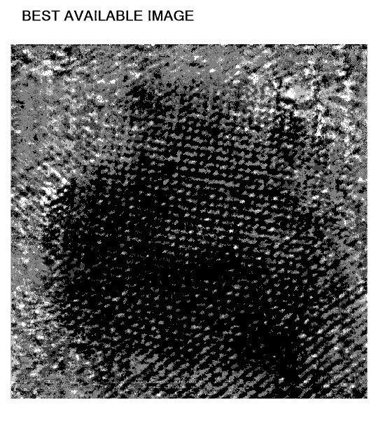

In FIG. 29, ESI-MS mass spectrum-5 of dmae₂-Zn₂(subPc)₂ compound is illustrated.

In FIG. 30 (25), HR-TEM image of the nano crystals obtained from CHCl₃ solution for the dmae₂-Zn₂(subPc)₂ dye is illustrated.

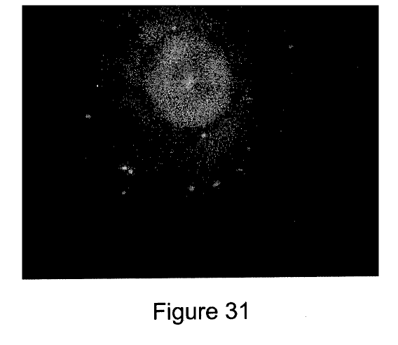

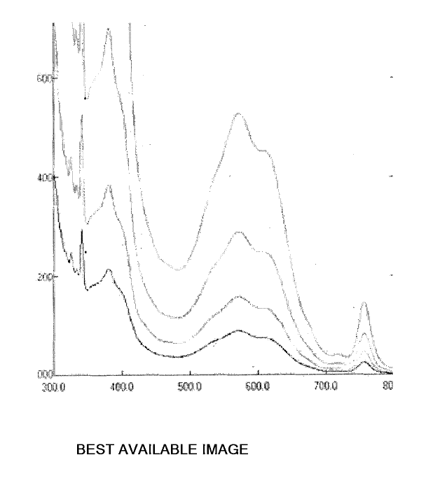

In FIG. 31 (26), the FFT reflection pattern of the nano crystals obtained from CHCl₃ solution for the dmae₂-Zn₂(subPc)₂ dye is illustrated.

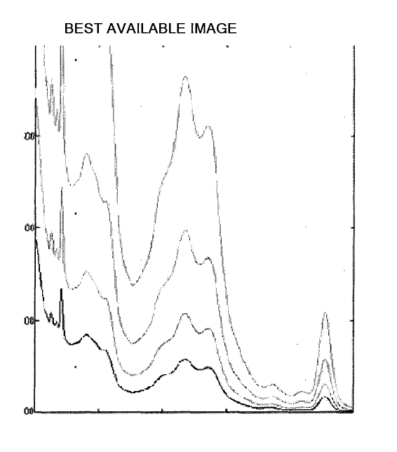

In FIG. 32 (27), UV-vis spectrums of Zn₂(subNc)₂ compound which are taken in (0.21-0.83)×10⁻⁴ M tetrahydrofuran are illustrated.

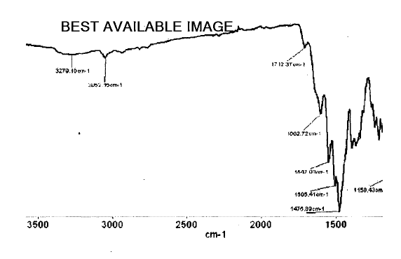

In FIG. 33 (28), the UV-vis spectrums of Zn₂(subNc)₂ compound which are taken in tetrahydrofuran/CH₃COOH in proportion of 50:1 in the concentration range of (0.21-0.83)×10⁻⁴ M are illustrated.

In FIG. 34 (29), the FT-IR spectrum of Zn₂(subNc)₂ compound is illustrated.

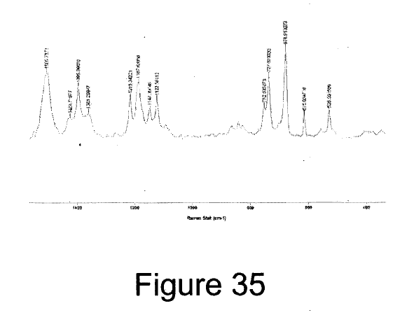

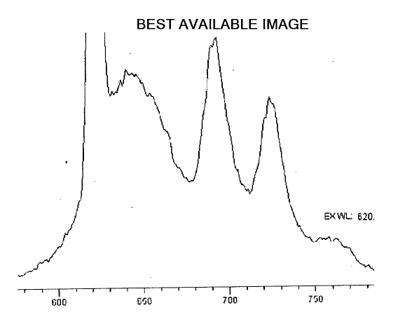

In FIG. 35 (30), the Raman spectrum of Zn₂(subNc)₂ compound is illustrated.

In FIG. 36 (31), the fluorescence spectrum of 0.83×10⁴ M tetrahydrofuran solution excited at 620 nm for the Zn₂(subNc)₂ compound is illustrated.

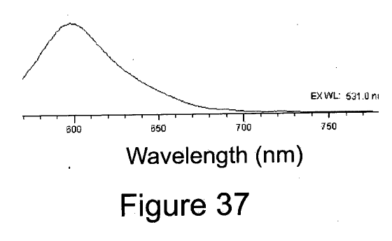

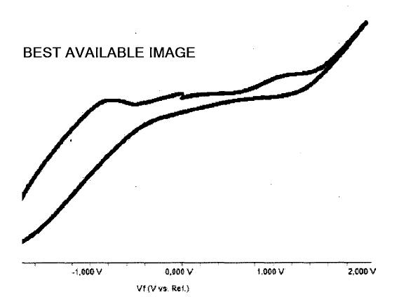

In FIG. 37 (32), the fluorescence spectrum of Zn₂(subNc)₂ compound in concentration of 0.83×10⁻⁴ M at a proportion of 50:1 in tetrahydrofuran/CH₃COOH by means of excitation in 531 nm is illustrated.

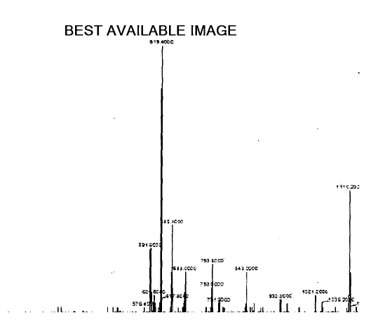

In FIG. 38 (33), the electrochemical current-voltage (CV) curve of the Zn₂(subNc)₂ compound is illustrated.

In FIG. 39 (34), ESI-MS mass spectrum of the Zn₂(subNc)₂ compound is illustrated.

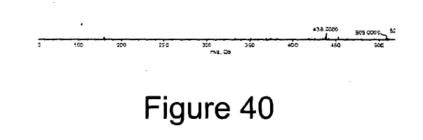

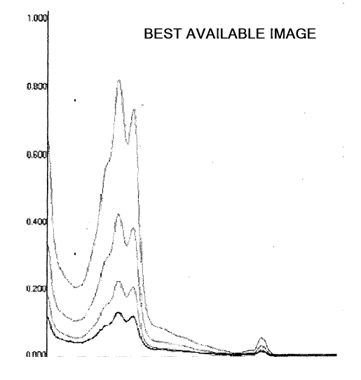

In FIG. 40 (35), ESI-MS mass spectrum of the Zn₂(subNc)₂ compound is illustrated.

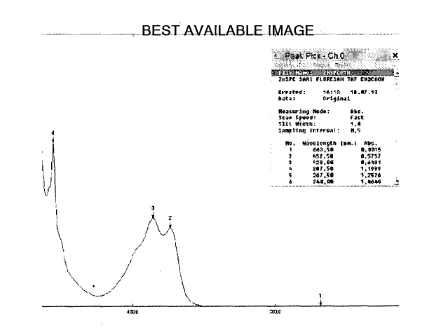

In FIG. 41 (36), the UV-vis spectrums of (CH₃COO)₂—Zn₂(subPc)₂ compound in (0.24-0.98)×10⁻⁴ M concentration range in CHCl₃/CH₃COOH at a proportion of 50:1 are illustrated.

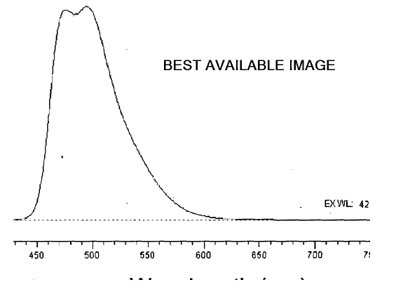

In FIG. 42 (37), the UV-vis spectrums of (CH₃COO)₂—Zn₂(subPc)₂ compound in 0.98×10⁻⁴ M concentration range in tetrahydrofuran/CH₃COOH at a proportion of 50:1 are illustrated.

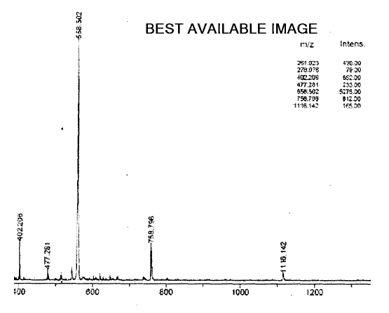

In FIG. 43 (38), the fluorescence spectrum of CHCl₃/CH₃COOH solution at a proportion of 50:1 for the compound of dmae₂Zn₂(subPc)₂ is illustrated.

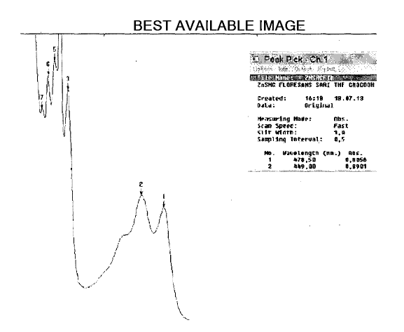

In FIG. 44 (39), Maldi-Tof-MS mass spectrum of (CF₃COO)₂—Zn₂(subPc)₂ is illustrated.

In FIG. 45 (40), the UV-vis spectrum of tetrahydrofuran/CH₃COOH solution at a proportion of 50:1 for (CH₃COO)₂—Zn₂(subNc)₂ is illustrated.

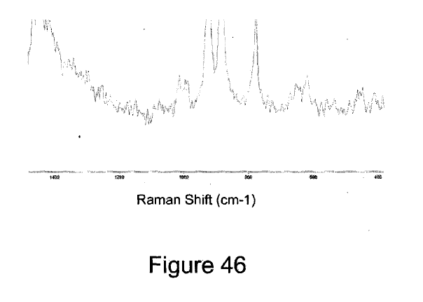

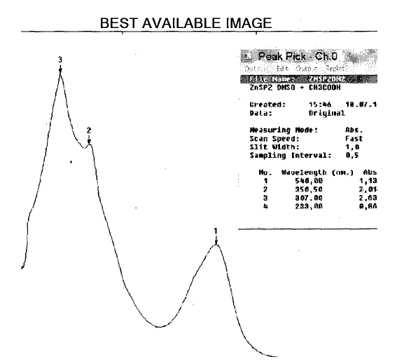

In FIG. 46 (41), the raman spectrum of (CH₃COO)₂—Zn₂(subNc)₂ is illustrated.

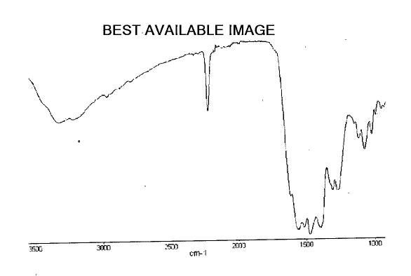

In FIG. 47 (42), the UV-vis spectrum of ZnsubPz type dye comprising Zn metal and aminoimidazole ring is illustrated.

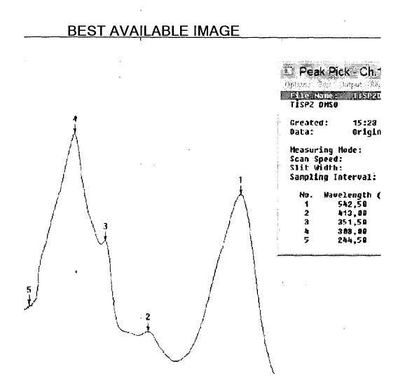

In FIG. 48 (43), the FT-IR spectrum of ZnsubPz type dye comprising Zn metal and aminoimidazole ring is illustrated.

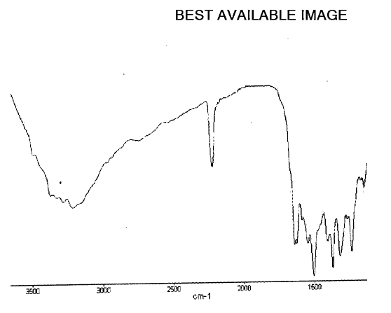

In FIG. 49 (44), the UV-vis spectrum of TisubPz type dye comprising Ti metal and aminoimidazole ring is illustrated.

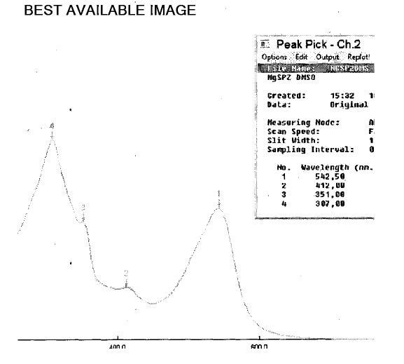

In FIG. 50 (45), the FT-IR spectrum of the TisubPz type dye comprising Ti metal and aminoimidazole ring is illustrated.

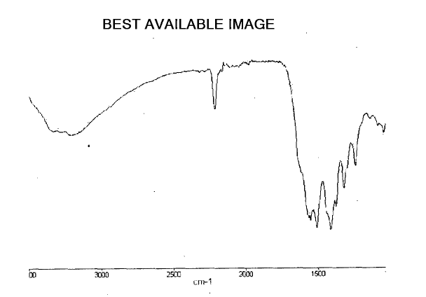

In FIG. 51 (46), the UV-vis spectrum of MgsubPz type dye comprising Mg metal and aminoimidazole ring is illustrated.

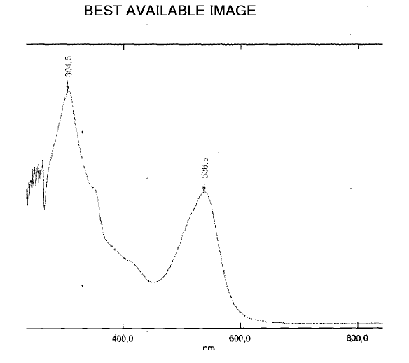

In FIG. 52 (47), the FTIR spectrum of MgsubPz type dye comprising Mg metal and aminoimidazole ring is illustrated.

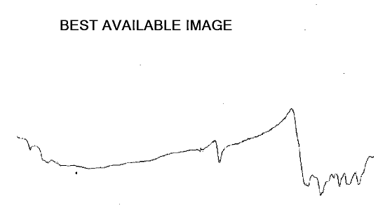

In FIG. 53 (48), the UV-vis spectrum of AlsubPz type dye comprising Al metal and aminoimidazole ring is illustrated.

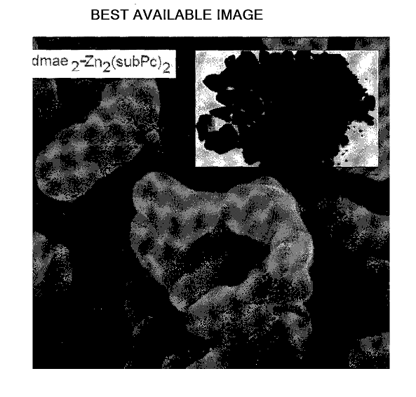

In FIG. 54 (49), the FTIR spectrum of AlsubPz type dye comprising Al metal and aminoimidazole ring is illustrated.

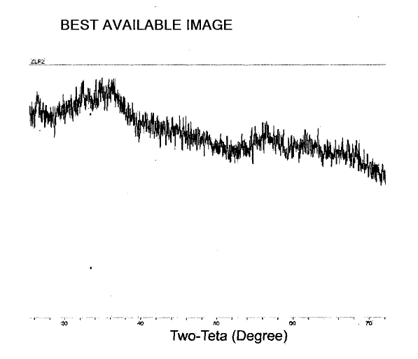

In FIG. 55 (50), the photograph and the FE-SEM image of the complex dye with structure of dmae₂-Zn₂(subPc)₂ are illustrated.

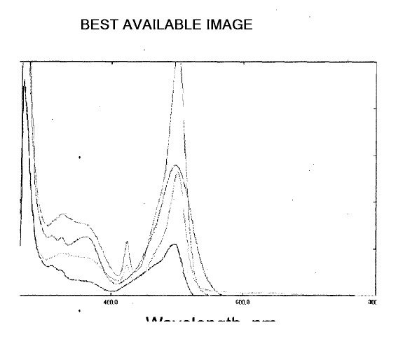

In FIG. 56, the x-ray diffraction (XRD) image of the complex dye with structure of dmae₂-Zn₂(subPc)₂ is illustrated.

In FIG. 57, the UV-vis spectrums obtained for X—ZnsubPr compound are illustrated.

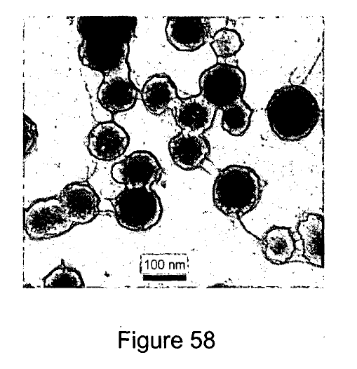

In FIG. 58, the TEM image of the Zn core centers of the composite nano dye is illustrated.

### THE DETAILED DESCRIPTION OF THE INVENTION

The present invention relates to metal complexes or coordination compounds formed by aromatic macrocyclic molecules like Phtalocyanine (Pc), Naphtalocyanine (Nc), Porphyrazine (Pz), Porphyrine (Pr), sub-Phtalocyanine (subPc), sub-Naphtalocyanine (subNc), sub-Porphyrazine (subPz), sub-Porphyrine (subPr), by means of a metal existing at the center thereof.

By means of the synthesis method, Phtalocyanine (Pc), Naphtalocyanine (Nc), Porphyrazine (Pz), Porphyrine (Pr), sub-Phtalocyanine (subPc), sub-Naphtalocyanine (subNc), sub-Porphyrazine (subPz), sub-Porphyrine (subPr) and the coordination compounds or metal complexes formed by them with a metal are synthesized.

The present invention moreover relates to acid, alcohol, thiol and amine derivatives of these metal macrocyclic complexes. It has been detected that these acid salts, obtained by reacting the subject matter metal macrocyclic complexes with an acid selected from acetic acid or trifluoroacetic acid, have better fluorescence characteristic when compared with the metal macrocyclic complexes. The organic or inorganic groups, described to be coordinated to the compounds at temperatures of 0-120° C., are defined as R—OH, Ar—OH, R—SH, Ar—SH, R—NH2, Ar—NH2, HCOOH, R—COOH, Ar—COOH, H2C2O4, R—SO3H, Ar—SO3H, OH—, CN—, Cl—, F—, NO3-, H2O, H3BO3, H3PO4, H2PO4- and the derivatives of them. Moreover, lactic acid, salicylic acid, benzoic acid, aconitic acid, sulfanilic acid, acrylic acid, phenyl.boronic acid and the derivatives thereof can be connected to the metal atom.

The present invention moreover relates to the synthesis of these compounds.

It has been observed that the synthesized products comprise Pc, subPc and Nano metal particles. New methods have been developed regarding the isolation and purification of them. It has been observed that SubPc type dyes generally bind to silica column and do not separate, and the separation of SubPc type dyes from neutral alumina columns has been easier. For instance, when the dark blue mixture, obtained by adding CHCl₃ to the reaction mixture of dmae₂-Zn₂(subPc)₂, is applied to the column, first of all, the light blue colored Pc phase has been separated, and in the second step, the red subPc phase is taken which can be dissolved in alcohol. Small amount of organic acid H⁺ addition has facilitated separation of subPc fractions from the column. However, it has been observed that in the mass analyses of products obtained in this manner, the acidic groups are bound to the structure. Moreover, it has been observed that the usage of strong acids like HCl has fragmented the structure of the product.

The metal powders, used in the subject matter synthesis method, are in the form of activated metal powders. The activated metal powders are in the form of nano metals or the milled mixtures of them (Patent No: 2014/06804). Preferably, nano metals are milled and activated by means of inert metal salts like MX and MX₂ (M: Li, Na, K, Mg, Ca, Sr, Ba, Ti, Zr, V, Cr, Mo, Mn, Re, Fe, Ru, Co, Rh, Ir, Ni, Pd, Pt, Cu, Ag, Au, Zn, Cd, B, Al, Ga, In, Si, Ge, Sn, Pb, Sb, Bi, Se, Te and X: F, Cl, Br, I, CH₃COO—, SO₄²—, C₂O₄²⁻, PO₄³⁻, NO₃⁻, OH⁻, CO₃²⁻, HCO₃⁻, H₂PO₄⁻, HPO₄²⁻). More preferably, in addition to the metal salts in the activation process of metal powders, various metal oxides (ZnO, TiO₂, SiO₂, Al₂O₃, MgO, Ca(OH)₂, B₂O₃), different ceramic materials (Hydroxyapatite and Zeolite powders) and some carbon based inert materials (paraffin, cellulose, active carbon, coal dust, graphite) are used as carrier support, protector and common catalyst.

Phtalocyanine (Pc), Naphtalocyanine (Nc) Compounds and the Synthesis of Metal Complexes Thereof Phtalocyanines have been prepared with and without metal. Here, said metals have been used as structure guide. Therefore, phthalonitrile, dimethyl terephthalonitrile, 4-substituted phthalonitriles, 3-substituted phthalonitriles, 4,5-disubstituted phthalonitriles, 3,6-disubstituted phthalonitriles, 3,4,5,6-tetra substituted phthalonitriles, phthalic anhydride, pyromellitic anhydride, 4-substituted phthalic anhydrides, 3-substituted phthalicanhydrides, 4,5-disubstituted phthalicanhydrides, 3,6-disubstituted phthalicanhydrides, 3,4,5,6-tetra substituted phthalicanhydrides, diimino isoindoline, 4-substituted diimino isoindolines, 3-substituted diimino isoindolines, 4,5-disubstituted diimino isoindolines, 3,6-disubstituted diimino isoindolines, 3,4,5,6-tetra substituted diimino isoindolines, cyanobenzamide, 4-substituted cyanobenzamides, 3-substituted cyanobenzamides, 4,5-disubstituted cyanobenzamides, 3,6-disubstituted cyanobenzamides, 3,4,5,6-tetra substituted cyanobenzamides, 1,3,3-trichloro isoindoline, 5-substituted-1H-isoindole-1,3-(2H) dithions, 1-imino-3-methylthio-5-substituted isoindolines and 1,2,4,5-tetracyanobenzene have been selected as the beginning materials together with the activated metal mixture.

Naphtalocyanines have been prepared with and without metal. Therefore, as the structure guide; naphthalonitrile, 6-substituted naphthalonitriles, 5-substituted naphthalonitriles, 6,7-disubstituted naphthalonitriles, 5,8-disubstituted naphthalonitriles, 5,6,7,8-tetra substituted naphthalonitriles, naphthenic anhydride, 6-substituted naphthenic anhydrides, 6,7-disubstituted naphthenicanhydrides, 5,8-disubstituted naphthenicanhydrides, 5,6,7,8-tetra substituted naphthenicanhydrides, benzo-diimino isoindoline, 6-substituted benzo diimino isoindolines, 5-substituted benzo diimino isoindolines, 6,7-disubstituted benzo diimino isoindolines, 5,8-disubstituted benzo diimino isoindolines, 5,6,7,8-tetra substituted benzo diimino isoindolines, cyanoaphthamide, 6-substituted cyanoaphthamides, 5-substituted cyanoaphthamides, 6,7-disubstituted cyanoaphthamides, 5,8-disubstituted cyanoaphthamides, 5,6,7,8-tetra cyanoaphthamides, 6,7-disubstituted cyanoaphthamides, 5,8-disubstituted cyanoaphthamides, 5,6,7,8-tetra substituted cyanoaphthamides, 2,3-Dicyano-1,4-dihydroxy-5-nitronaphthalene and 1,4-diamino-2,3-dicyano-9,10-anthraquinone have been selected as the beginning materials together with the activated metal mixture.

In the synthesis of substituted phtalocyanines and naphtalocyanines, as the substituent group, one of the following groups has been used: amino, nitro, dimethyl amine, diethylamine, dialkyl amines, diphenyl amine, diaryl amines: metoxy, etoxy, poriloxy, isopropiloxy, normal butoxy, isobutoxy, tertiarybutoxy, normal pentoxy, isopentoxy, neopentoxy, normalhexyloxy, normal heptiloxy, normaloctiloxy, normaldexyloxy, normaldodexyloxy, phenoxy, methyiphenoxy, dimethylphenoxy, naphtoxy, thiophenoxy, thionaphtoxy, substituted thiophenoxy, substituted thionaphtoxy, thiometoxy, thioetoxy, thionormal propoxy, thioisopropoxy, thionormalbutoxy, thioisobutoxy, thiotertiarybutoxy, thionormalpentoxy, thioisopropoxy, thioneopentoxy, thionormalheptoxy, thionormaloctiloxy, thionormaldeciloxy, thionormaldodeciloxy, ethyl, propyl, isopropyl, normalbutyl, isobutyl, tertiarybutyl, normal pentyl, isopentyl, neopentyl, 4-q-cumilphenoxy, chlorine, bromine, iodine, fluorine, 2,6-dimethyl phenoxy groups.

The reactions have been realized in inert atmosphere or preferably under vacuum. Nitrogen gas, CO₂ gas or argon gas have been used as the inert atmosphere.

In the reactions, mono alcohols with high molecular weight, mono alcohols with low molecular weight, poly alcohols with high molecular weight, poly alcohols with low molecular weight and polyethylene glycols with low and high molecular weight have been used as solvent. In addition to these solvents; alkyl amines, mono ethanol amine, substituted mono ethanol amines, N,N-dimethyl ethanol amine (DMAE), diethanol amine, triethanol amine, ethylene diamine, substituted ethylene diamines, polyethylene amines, morpholine, piperazine, pyridine, substituted pyridines, N alkyl and N,N dialkyl amine substituted pyridines, the substances comprising pyrimidine rings, quinoline, urea, substituted urea, dimethyl urea, tetramethyl urea, aniline, substituted anilines, acetamide, substituted acetamides, formamide, substituted formamides, toluene, xylene, dimethylsulphoxide, ethylene glycol, glycerin and water have been used.

In the reactions, the following have been used for catalytic purposes optionally: 1,5,7-triazabicyclo(4.4.0)dek-5-en (TBD), 7-Methyl-1,5,7-triazabicyclo(4.4.0)dek-5-en (MTBD), 1,8-Diazabicyclo[5.4.0] undec-7-ene (DBU), 1,5-Diazabicyclo[4.3.0] non-5-en (DBN), 1,1,3,3-Tetramethylguanidine (TMG), Quinochlidine, 2,2,6,6-Tetramethylpiperidine (TMP), Pempidine (PMP), Tributhylamine, Triethylamine, 1,4-Diazabicyclo[2.2.2] octane (TED), Collidine, 2,6-Lutidine (2,6-Dimethylpyridine), N-methyl prolidone (NMP), steric bases and sodium acetate, sodium carbonate, sodiumbicarbonate, trisodiumphosphate, potassiumcyanide, sodiumsulfide and sodiummetabisulfide basic salts.

The reaction temperatures were between 20-200° C., and preferably between 140-160° C., and more preferably between 150-155° C. The reaction duration has been applied as 15-720 minutes. Preferably, reaction duration of 240-720 minutes, and more preferably 500-720 minutes has been applied.

### Sub-Phtalocyanine (Pc), Sub-Naphtalocyanine (Nc) Compounds and the Synthesis of Metal Complexes Thereof

Subphtalocyanines have been prepared with and without metal. Here, said metals have been used as structure guide. Therefore, phthalonitrile, 4-substituted phthalonitriles, 3-substituted phthalonitriles, 4,5-disubstituted phthalonitriles, 3,6-disubstituted phthalonitriles, 3,4,5,6-tetra substituted phthalonitriles, phthalic anhydride, pyromellitic anhydride, 4-substituted phthalic anhydrides, 3-substituted phthalicanhydrides, 4,5-disubstituted phthalicanhydrides, 3,6-disubstituted phthalicanhydrides, 3,4,5,6-tetra substituted phthalicanhydrides, diimino isoindoline, 4-substituted diimino isoindolines, 3-substituted diimino isoindolines, 4,5-disubstituted diimino isoindolines, 3,6-disubstituted diimino isoindolines, 3,4,5,6-tetra substituted diimino isoindolines, cyanobenzamide, 4-substituted cyanobenzamides, 3-substituted cyanobenzamides, 4,5-disubstituted cyanobenzamides, 3,6-disubstituted cyanobenzamides, 3,4,5,6-tetra substituted cyanobenzamides, 1,3,3-trichloro isoindoline, 5-substituted-1H-isoindole-1,3-(2H) dithions, 1-imino-3-methylthio-5-substituted isoindolines have been selected as the beginning materials together with the activated metal mixture.

Subnaphtalocyanines have been prepared with and without metal. Therefore, as the structure guide; naphthalonitrile, 6-substituted naphthalonitriles, 5-substituted naphthalonitriles, 6,7-disubstituted naphthalonitriles, 5,8-disubstituted naphthalonitriles, 5,6,7,8-tetra substituted naphthalonitriles, naphthenic anhydride, 6-substituted naphthenic anhydrides, 6,7-disubstituted naphthenicanhydrides, 5,8-disubstituted naphthenicanhydrides, 5,6,7,8-tetra substituted naphthenicanhydrides, benzo-diimino isoindoline, 6-substituted benzo diimino isoindolines, 5-substituted benzo diimino isoindolines, 6,7-disubstituted benzo diimino isoindolines, 5,8-disubstituted benzo diimino isoindolines, 5,6,7,8-tetra substituted benzo diimino isoindolines, cyanoaphthamide, 6-substituted cyanoaphthamides, 5-substituted cyanoaphthamides, 6,7-disubstituted cyanoaphthamides, 5,8-disubstituted cyanoaphthamides, 5,6,7,8-tetra substituted cyanoaphthamides have been selected as the beginning materials together with the activated metal mixture.

The reactions have been realized in inert atmosphere or preferably under vacuum. Nitrogen gas, CO₂ gas or argon gas have been used as the inert atmosphere.

In the reactions, mono alcohols with high molecular weight, mono alcohols with low molecular weight, poly alcohols with high molecular weight, poly alcohols with low molecular weight and polyethylene glycols with low and high molecular weight have been used as solvent. In addition to these solvents, alkyl amines, mono ethanol amine, substituted mono ethanol amines, N,N-dimethyl ethanol amine (DMAE), diethanol amine, triethanol amine, ethylene diamine, substituted ethylene diamines, polyethylene amines, morpholine, piperazine, pyridine, substituted pyridines, N alkyl and N,N dialkyl amine substituted pyridines, the substances comprising pyrimidine rings, quinoline, urea, substituted urea, dimethyl urea, tetramethyl urea, aniline, substituted anilines, acetamide, substituted acetamides, formamide, substituted formamides, toluene, xylene, dimethylsulphoxide, ethylene glycol, glycerin and water have been used.

In the reactions, the following have been optionally used for catalytic purposes: 1,5,7-triazabicyclo(4.4.0)dek-5-en (TBD), 7-Methyl-1,5,7-triazabicyclo(4.4.0)dek-5-en (MTBD), 1,8-Diazabicyclo[5.4.0] undek-7-ene (DBU), 1,5-Diazabicyclo[4.3.0] non-5-en (DBN), 1,1,3,3-Tetramethylguanidine (TMG), Quinochlidine, 2,2,6,6-Tetramethylpiperidine (TMP), Pempidine (PMP), Tributhylamine, Triethylamine, 1,4-Diazabicyclo[2.2.2] octane (TED), Collidine, 2,6-Lutidine (2,6-Dimethylpyridine), N-methyl prolidone (NMP), steric bases and sodium acetate, sodium carbonate, sodiumbicarbonate, trisodiumphosphate, potassiumcyanide, sodiumsulfide and sodiummetabisulfide basic salts.

The reaction temperatures were between 20-200° C., and preferably between 40-140° C., and more preferably between 60-120° C. The reaction duration has been applied as 15-720 minutes. Preferably, reaction duration of 15-240 minutes, and more preferably 30-120 minutes has been applied.

### Porphyrazine (Pz), Sub-Porphyrazine (Pz) Compounds and the Synthesis of Metal Complexes Thereof

Porphyrazines have been prepared with and without metal. Here, said metals have been used as structure guide. Therefore, the following ligands have been used together with the activated metal mixture: Diaminomaleonitrile, 1,4,5,6-Tetrahydro-5,6-dioxo-2,3-phyrazinedicarbontirile, 4,5-dicyanoimidazole, 2-amino-4,5-dicyano-1H-imidazole, 2,3-dicyano-5-methylphyrazine, 5,6-diamino-2,3-dicyanophyrazine, 2,3-dicyanophyrazine, 5-Amino-6-chloro-2,3-dicyanophyrazine, 5,6-dichloro-2,3-dicyanophyrazine, 2,3-Bis(4-bromophenyl)-2-butenedinitrile, 4,5-Dicyano-1,3-dithiol-2-one, 2,3-Dichloro-5,6-dicyano-1,4-benzoquinone, Tetracyanoethylene, Disodium Dimercaptomaleonitrile, cis-1,2-Dicyano-1,2-bis(2,4,5-trimethyl-3-thienyl)ethane, 5,6-Diamino-2,3-dicyanophyrazine, 5-Amino-6-chloro-2,3-dicyanophyrazine, 5,6-Dichloro-2,3-dicyanophyrazine ligands.

The reactions have been realized in inert atmosphere or preferably under vacuum. Nitrogen gas, CO₂ gas or argon gas have been used as the inert atmosphere.

The reaction temperatures were between 20-200° C., and preferably between 140-160° C., and more preferably between 150-155° C. The reaction duration has been applied as 15-720 minutes. Preferably, reaction duration of 240-720 minutes, and more preferably 500-720 minutes has been applied.

In the reactions, mono alcohols with high molecular weight, mono alcohols with low molecular weight, poly alcohols with high molecular weight, poly alcohols with low molecular weight and polyethylene glycols with low and high molecular weight have been used as solvent. In addition to these solvents; alkyl amines, mono ethanol amine, substituted mono ethanol amines, N,N-dimethyl ethanol amine (DMAE), diethanol amine, triethanol amine, ethylene diamine, substituted ethylene diamines, polyethylene amines, morpholine, piperazine, pyridine, substituted pyridines, N alkyl and N,N dialkyl amine substituted pyridines, the substances comprising pyrimidine ring, quinoline, urea, substituted urea, dimethyl urea, tetramethyl urea, aniline, substituted anilines, acetamide, substituted acetamides, formamide, substituted formamides, toluene, xylene, dimethylsulphoxide, ethylene glycol, glycerin and water have been used.

Porphyrine (Pr), Sub-Porphyrine (subPr) Compounds and the Synthesis of Metal Complexes Thereof

The following have been used as reactant: pyrrole, 3-methylpyrrole, 3-n-octilpyrrole, Acetaldehyde, benzaldehyde, propypoaldehyde, n-buthiraldehyde, isobuthiraldehyde, trimethylacetaldehyde, cyclopropancarboxyaldehyde, para-methylbenzaldehyde, 2-aldopyridine, 3-aldopyridine, 4-aldopyridine, para-hydroxybenzaldehyde, meta-hydroxybenzaldehyde, parachlorobenzalheyde, metachlorobenzaldehyde, ortochlorobenzaldehyde, parabromobenzaldehyde, metabromobenzaldehyde, orthobromobenzaldehyde, parafluorobenzaldehyde, metafluorobenzaldehyde, orthofluorobenzaldehyde, paraiodobenzaldehyde, metaiodobenzaldehyde, othoiodobenzaldehyde, 3,5-dimethylbenzaldehyde, cumineladehyde, ortho-, meta-, para-metoxybenzaldehyde, 1,3,5,-trioxan, paraformaldehyde, para-, meta-, ortho-nitrobenzaldehyde, 2, 4, 6 trisubstituted benzaldehydes, 1-naphthaldehyde, para-, meta-, ortho-mercaptobenzaldehyde, 4-dimethylamino-benzaldehyde, cyclopentan carboxyaldehyde, cyclohexan carboxyaldehyde, tertiarybutyl carboxyaldehyde.

In the reaction; formic acid, acetic acid, trifluoroacetic acid, propionic acid, butyric acid, lactic acid, citric acid, p-toluene sulfonic acid, succinic acid, salicylic acid, benzoic acid and the derivatives thereof have been preferred as the weak organic acid.

In the reactions; preferably ethylene glycol, glycerin, dimethylsulphoxide, xylene, toluene, methylene, chloride, dichloroethane, nitrobenzene, methanol, pyridine, p-chloraniline, chlorobenzene and dichlorobenzene have been used.

The reaction temperatures were between 20-180° C., and preferably between 120-150° C., and more preferably between 80-120° C. The reaction duration has been applied as 15-720 minutes. Preferably, reaction duration of 240-720 minutes, and more preferably 500-720 minutes has been applied. In the present invention, besides the normal thermal processes used for increasing the temperature value; microwave synthesis, photo thermal synthesis, synthesis under pressure, photochemical methods, electrochemical and solid-phase grinding methods can also be used.

### Example 1

### Synthesis of Dea-BsubPc

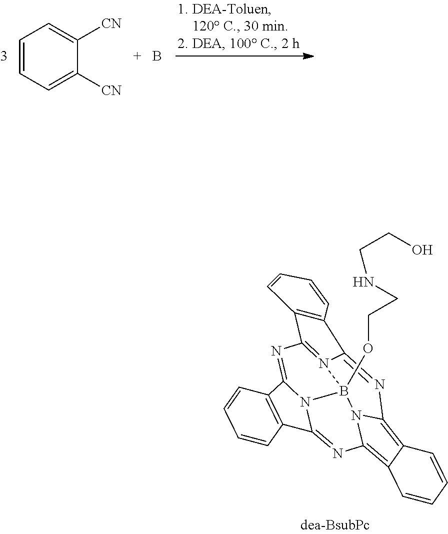

The synthesis of dea-BsubPc from boron powder and the molecule structure of the new product are given above. The powder mixture comprising B or approximately 0.16 grams of powder B has been mixed in inert gas medium or vacuum conditions for duration of 30-120 minutes in 50% 10 ml diethanolamine (dea)-toluene mixture at temperature of 120° C. with 5.28 grams of Phthalonitrile (PN). Approximately 0.2-0.5 grams of KCl has been added to the reaction medium beforehand. The reaction mixture has been transformed into dark blue after duration of approximately 10-15 minutes, and it has been observed that color intensity has increased during the advancing reaction. In the second step, the clear organic toluene phase, which is formed on the viscose mixture cooled down to room temperature, has been decanted and separated. The remaining reaction mixture has been washed at least three times by means of acetone of 20-50 ml. Viscose oily reaction mixture has been waited at room temperature in a dark place inside hexane-acetone mixture until red color is formed. Preferably if a more rapid reaction and a transformation into a stable final product are desired, the oily portion, including limited amount of dea, has been heated for 1-2 hours at temperature of 100° C. until red color is formed. The mixture, which has been cooled at room temperature, has been washed with substantial amount of tetrahydrofuran in a stepped manner, and the impurities have been eliminated. The unresolved residue has been resolved in 40-50 ml of methanol, and afterwards it is filtered and removed. The reddish pink methanol solution has been evaporated by means of the evaporator until dryness is obtained. The residue has been taken into 5-10 ml 1/1 methanol-acetone mixture and it has been precipitated by means of hexane-ether addition. The pure product obtained has been centrifuged and separated and it has been dried for 2 hours at 100° C. The approximate product amounts obtained in different reaction conditions and the reaction efficiencies calculated for dea-BsubPc have been given in the table below.

TABLE 1
The approximate product amounts obtained in different reaction conditions
and the reaction efficiencies calculated for dea-BsubPc

| | Amount of | | | | | |
|---|---|---|---|---|---|---|
| The Activated | Activated | | | | | |
| Metal | Powder | | | | | |
| Composition | Mixture Used | | | | BsubPc | dea- |
| Used in | in the | Phthalonitrile | Reaction | Reaction | Product | BsubPc |
| Reaction | Reaction | amount | temperature | Duration | amount | Efficiency |
| (m/m) % | (g) | (g) | (° C.) | (minute) | (mg) | % |
| B-PN-KCl | 0.0864 | 0.7470 | 120 | 60 | 42-84 | 4.4-8.8 |
| 25% B, 25% | | | | | | |
| PN, 50% KCl | | | | | | |
| B + PN + KCl | 2.64 + | 2.6400 | 120 | 90 | 1000-1200 | 13.5-16.2 |
| 25% B, 25% | 0.25 g KCl | | | | | |
| PN, 50% KCl | | | | | | |
| B-PN | 0.0432 | 0.7254 | 120 | 60 | 15-30 | 1.5-3.0 |
| B-KCl | 0.0432 | 0.7686 | 120 | 60 | 40-80 | 4.0-8.0 |
| B activated | 0.0216 | 0.7686 | 120 | 60 | 5-10 | 0.5-1.0 |
| B original | 0.0216 | 0.7686 | 120 | 60 | 10-20 | 1.0-2.0 |
| commercial | | | | | | |
| B original | 0.33 | 2.6400 | 120 | 90 | 200-400 | 5.4-10.8 |
| commercial + | | | | | | |
| KCl | | | | | | |
| 24.2% B, | | | | | | |
| 75.8% KCl | | | | | | |

In FIG. 1, the UV-vis spectrums taken in 0.25×10⁻⁴ M-2×10⁻⁴ M MeOH solutions for the dea-BsuPc compound are given. There are two peaks at 559 nm and 525 nm as Q bands for the π→π* passages for the Sub-phtalocyanine ring in the UV-Vis spectrum taken in methanol for the dea-BsubPc compound. This supports the low symmetry C_{3V} symmetry of the Sub-phtalocyanine ring. The B bands, corresponding to the lower energy passages and belonging to the deeper π→π* passages, have occurred at 320 nm with lower molar absorption coefficients. The molar absorption coefficients calculated as logs for these peaks are calculated to be 3.54, 3.35 and 3.60 respectively (FIG. 1).

In the FTIR spectrum of the dea-BsubPc (Boron-sub-phtalocyanine-diethanolamine) compound given in FIG. 2, it is illustrated that two peak diethanol amine groups rising above 3100 cm-1 are coordinated to the B atom of the B—SPc macrocyclic ring through one of oxygen atoms by means of B—O interaction. In the spectrum, the peaks rising above 3335 cm⁻¹ and 3150 cm⁻¹ are respectively the O—H and N—H tensioning vibrations of the DEA group. It has been detected that the ═C—H tension vibrations of the aromatic groups of the BSpc ring occur at 3045 cm⁻¹, and the aliphatic C—H tensions of the DEA group occur at 2870-2820 cm⁻¹. The C═N tensions of the isoindoline groups on the sub-phtalocyanine ring occur at 1630 cm⁻¹, and the C═C tension vibrations of the aromatic groups of this macrocyclic ring occur at 1538 cm⁻¹. As expected, the C—C single bound tensions of the aliphatic groups occur at 1460 cm⁻¹. It has been detected as the tension vibration of the B—O bound proving that DEA binds through the O atom to the peak axial position observed in intermediate intensity at 1329 cm⁻¹. The other band, having intermediate intensity occurring at 1270 cm-1, belongs to the B—O—C tension vibration. The C—O single bound tensioning vibration is observed at 1059 cm-1. The other peaks detected in the spectrum are 975 cm⁻¹ and 681 cm⁻¹.

In the ¹H-NMR spectrum of the dea-BsubPc (Boron-sub-phtalocyanine-diethanolamine) compound illustrated in FIG. 3, the peaks of the aromatic ring have occurred between 8.36 ppm and 7.11 ppm. In the benzene ring occurring in 8.36 ppm and marked with 1 in FIG. 5, the singlet having value of 3H for the protons existing on the carbon atoms which are adjacent to the pyrrole rings can be seen. This structure is substantially aromatic for the boron-bound Sub phtalocyanine ring, and it has been appreciated that three adjacent protons shift to the low region and they do not enter into spin interaction with the aromatic ring protons due to the electro negative effect of the pyrrole ring. The other aromatic group protons have occurred as doublet, doublet and triplet at 8.12 ppm, 7.97 ppm and 7.86 ppm respectively. The aromatic proton values, which are in interaction with the dea group which is bound as axial group and which occurs specific to these aromatic groups of the compound, have been recorded as multiplet between 7.56-7.11 ppm. The integral values of these protons of the compound are three 3H, and the total value is 9H, and they totally provide the value of 12H belonging to the aromatic ring. The CH2 group protons of the diethanol amine (dea) group, bound to the B atom of the dea-BsubPc compound through one of the oxygen atoms, have been observed as 4 different triplets between 4.15 ppm and 3.17 ppm. Some of these peaks are illustrated as solvent peaks whose intensity is high since the solubility is low, and they are illustrated as shoulders under the water peaks inside the solvent (FIG. 3). In the compound, the free OH proton and NH proton for the diethanol amine group have been recorded as wide bands at 5.36 ppm and at 4.88 ppm respectively.

In FIG. 4-6, the fluorescence spectrum of methanol solution excited at 500 nm, 510 nm and 561 nm for the dea-BsubPc compound is illustrated.

When the absorption bands observed in the fluorescence spectrum of the compound are excited at different wavelengths, peaks having different emission intensities and Stokes shifts have been obtained. When excitation has been made by using light with wavelength of 500 nm in the fluorescence spectrum, a single peak has been obtained having relatively lower emission efficiency. The Stokes shift value of this peak is 83 nm (FIG. 4). When the same sample is excited at 510 nm, the emission band having higher emission efficiency is detected to be 580 nm, and when excitation at 561 nm is realized, a single peak has been detected having high emission efficiency at 640 nm. The Stoks shifts of these emission bands of the compound have been detected to be 70 nm and 79 nm respectively (FIG. 5, 6).

In FIG. 7, the electrochemical current-voltage (CV) curve of the methanol solution for the dea-BsubPc compound is illustrated.

In FIGS. 8 and 9, ESI-MS mass analysis results for the dea-BubPc compound is illustrated. In the MS-MS mass spectrum of the B—SPc-DMAE compound, the peak, detected at m/e: 498.8, has been interpreted as molecular ion peak. The [M]⁺ value of the C₂₈H₂₂BN₇O₂, which is the molecule formula for this peak calculated theoretically, is equal to 499.3. The peak, recorded at m/e: 385.0 in the spectrum, belongs to DEA and belongs to the subphtalocyanine ring which has lost boron, and the [M-B-DEA]⁺, whose closed formula is C24H12N6, has been calculated to be 384.3.

### Example 2

### The Synthesis of Dea-BsubNc

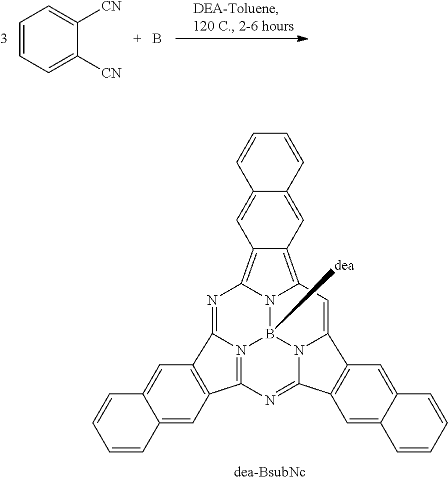

The synthesis of dea-BsubNc from boron powder or from the activated boron powder mixture and the molecule structure of the new product are given above.

1.78 grams of Naphthalonitrile has been mixed in inert gas medium or vacuum conditions for duration of 30-120 minutes in 50% 4 ml diethanolamine (dea)-toluene mixture at temperature of 120° C. Approximately 0.2-0.5 grams of KCl has been added to the reaction medium beforehand. The continuing processes in the reaction have been applied as given in example 1. The product formed has been taken from the reaction medium by means of extraction with tetrahydrofuran (THF).

In FIG. 10, UV-vis spectrum of the dea-BsubNc compound, and in FIG. 11, the FTIR spectrum of the dea-BsubNc compound, and in FIG. 12 and FIG. 13, the fluorescence spectrums of the dea-BsubNc compound are illustrated.

### Example 3

### The Synthesis of Dmae₂-Zn₂(subPc)₂ by Using Zn Powder

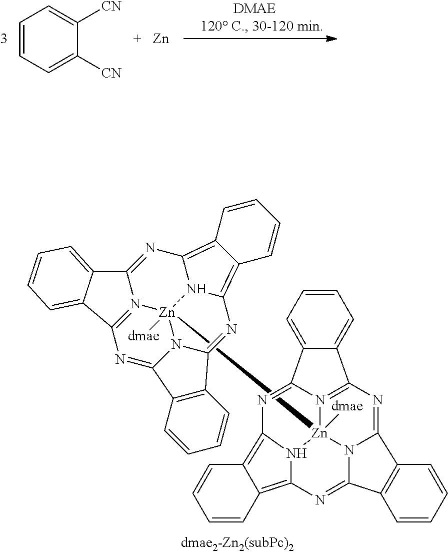

The synthesis of dmae₂-Zn₂(subPc)₂ from zinc powder and the molecule structure of the new product are given above.

The activated powder mixture including approximately 0.64 grams of Zn powder, has been mixed 3.75 grams of Phthalonitrile (PN) in inert gas medium or vacuum conditions for duration of 30-120 minutes in 5-7 ml dimethylaminoethanol (DMAE) mixture at temperature of 120° C. The reaction mixture has been transformed into dark blue after duration of approximately 10-15 minutes, and it has been observed that color intensity has increased during the advancing reaction. Preferably if a more rapid reaction and a transformation into a stable final product are desired, the reaction mixture has been heated for 0.5-2 hours at temperature of 120° C. The mixture, which has been cooled down to room temperature, has been washed with substantial amount of hexane and diethylether respectively in a stepped manner, and the impurities have been eliminated. The unresolved residue has been resolved in 40-50 ml of methanol, and it has been waited in a cold medium for 24 hours. Afterwards, the dmae₂-Zn₂(subPc)₂ product existing in the solution has been filtered and eliminated. The purple pink methanol solution has been evaporated by means of the evaporator until dryness is obtained. The pure product obtained has been separated and it has been dried for 1 hour at 50-100° C. Preferably, the chloroform solution of the raw reaction product has been passed through silica-gel (SiO₂) column, and it has been purified. Preferably, alumina (Al₂O₃) column has been used.

In FIG. 14, the UV-Vis spectrums of dmae₂-Zn₂(subPc)₂ compound in (0.24-0.94)×10⁴ M tetrahydrofuran (THF) are illustrated. In FIG. 15, the UV-Vis spectrums of dmae₂-Zn₂(subPc)₂ compound in (0.24-0.94)×10⁻⁴ M concentration range in THF/CH₃COOH are illustrated. In FIG. 16, the UV-vis spectrums of dmae₂-Zn₂(subPc)₂ compound in methanol are illustrated.

In the UV-Vis spectrum (FIG. 14) of the dmae₂-Zn₂(subPc)₂ compound taken in THF, the Q bands of the π→π* passages of the Sub-phtalocyanine ring have been observed at 560.5 nm and 600 nm as two peaks, and B bands corresponding to higher energy passages and for the deeper π→π* passages have been observed at 380 nm. The molar absorptivity coefficients of these passages have been calculated as log c, and have been determined to be 4.30 and 4.32 respectively. The log ε value determined for B band is 4.50. In the UV-Vis spectrums of the compound taken in THF/CH₃COOH mixture (FIG. 15), it has been observed that the solubility increases and the Q bands shift to blue as a result of application of proton to the nitrogen atoms inside the ring. The peaks for these passages are in the form of double shoulders, and these peaks have been detected as 517.5 and 530 nm. The log a values calculated for these passages are 4.65 and 4.55 respectively. While there is no shift in B band for the compound, the calculated log ε value is 4.67.

In the FTIR spectrum of the dmae₂-Zn₂(subPc)₂ (Zinc-sub-phtalocyanine-dimethylaminoethanol) compound given in FIG. 17, there is O—H tension of the wide peak dimethyl aminoethanol group having low intensity and occurring at 3314 cm⁻¹, it is referred that each Zn-SPc macrocyclic ring is coordinated to the Zn atom through the oxygen atom. The C—H tension vibrations of the aromatic groups of the subphtalocyanine ring are observed to be in the range of 3062 cm-1. The aliphatic C—H tensions, belonging to the dmae group connected to the Zn atom coordinated to the nitrogen atoms inside the ring, have been observed at 2927 cm⁻¹. The C═N tensions, belonging to the isoindoline groups provided on the subphtalocyanine ring, have been observed at 1601 cm⁻¹, and the C═C tension vibrations, belonging to the aromatic groups of this macrocyclic ring, have occurred in the range between 1548-1505 cm⁻¹. As expected, the C—C single bound tensions for the aliphatic groups have been observed in the range between 1460 and 1374 cm⁻¹. The peak, occurring in intermediate intensity and recorded at 1178 cm⁻¹, are evaluated as C—N tensions for the isoindoline ring, and the peaks occurring at 1125 cm⁻¹ and 1102 cm⁻¹ have been detected as C—N and C—O tension vibrations for the dmae group. The other important peaks recorded in the spectrum are 754 cm⁻¹ and 716 cm⁻¹.

In FIG. 18, the Raman spectrum of dmae₂-Zn₂(subPc)₂ compound is illustrated. The peaks determined in Raman spectrum, taken for characterizing the Zn—Zn bound of the subphtalocyanine compound having dimeric structure in the dmae₂-Zn₂(subPc)₂ structure, support the structure. The peaks detected for this spectrum are determined to be 1663, 1619, 1591, 1570, 1535, 1524, 1475, 1423, 1395, 1200, 1140,1105, 715, 350, 315 ve 259 cm⁻¹ respectively. These peaks are observed in the graphic given in FIG. 18.

In the ¹H-NMR spectrum (FIG. 19) of the dmae₂-Zn₂(subPc)₂ (Zinc-subphtalocyanine-diethanolamine) compound, the peaks, belonging to the aromatic ring, have occurred in the range between 8.17 ppm and 7.41 ppm. The integral values of these aromatic protons have a total value of 24 H. One of the isoindoline rings of the compound is in reduced position and the N—H proton of this ring is in a condition exchangeable with D₂O, and it has occurred as singlet with value 2H and 6.06 ppm. CH₂ aliphatic protons bound to the O of the dmae-Zn-SpC piece have been observed as multiplet in the range between 3.50 and 3.40 ppm. The integral values for these protons are 4H. Again CH₂ group protons bound to the N of the dmae group in coordinated condition have occurred in the range between 2.51 and 2.50 ppm as quartet. The integration values of these peaks prove the 2H proton value. The O—H protons of the bound dmae group have been observed at 3.29 ppm and 3.11 ppm as two different singlets at value of 1H.

In FIG. 20, the fluorescence spectrum of dmae₂-Zn₂(subPc)₂ compound taken in 0.94×10⁻⁴ M concentration in THF by means of excitation of light with wavelength of 545 nm is illustrated. In FIG. 21, the fluorescence spectrum of dmae₂-Zn₂(subPc)₂ compound in 0.94×10⁻⁴ M concentration in THF/CH₃COOH by means of 510 nm excitation is illustrated. In FIG. 22, the fluorescence spectrum of dmae₂-Zn₂(subPc)₂ compound in 0.94×10⁻⁴ M concentration in THF/CH₃COOH by means of 550 nm excitation is illustrated.

In the Fluorescence spectrum of the compound taken in THF, absorption band is excited by 545 nm and two bands at 575 nm and 640 nm have been detected as high emission band. The Stokes shift of the compound which has been detected for the excitation and emission bands has been detected as 40 nm and 105 nm respectively. In the fluorescence spectrum of the compound taken in THF/CH₃COOH solution, excitation has been made at 510 nm, and the emission intensity has increased at 580 nm in opposite to the sample taken in THF solution, and a single band has been detected. The Stokes shift which has been detected for this peak has been detected to be 70 nm.

In FIG. 23, the electrochemical current-voltage (CV) curve of the dmae₂-Zn₂(subPc)₂ compound is illustrated.

In FIG. 24, Maldi-tof-MS mass spectrum of dmae₂-Zn₂(subPc)₂ compound is illustrated.

In FIG. 25-29, ESI-MS mass spectrum of the compound is illustrated. In the ESI-MS spectrum for the [Zn₂(H₂SPc)₂-DMAE₂] compound, the peak occurring at m/e: 1079.6 has been interpreted as molecular ion peak. For this peak which proves that the molecule is in dimeric structure, the molecule closed formula calculated theoretically is C₅₆H₄₆Zn₂N₁₄O₂, and the calculated theoretical mass value, [M+1]⁺ is equal to 1078.8. The peak, occurring as m/e: 1077 in the spectrum, is calculated as [M]⁺−1. The peaks having lower m/e value occurring in the spectrum are calculated as [M/2−2]⁺ for m/e: 537 and [M/2-Zn-DMAE]⁺ for m/e: 385.

In FIG. 30, HR-TEM image of the nano crystals obtained from CHCl₃ solution for the dmae₂-Zn₂(subPc)₂ dye is illustrated and in FIG. 31, the FFT reflection pattern of the nano crystals obtained from CHCl₃ solution for the dmae₂-Zn₂(subPc)₂ dye is illustrated.

### Example 4

### The Synthesis of Zn₂(subNc)₂ by Using Zn Powder

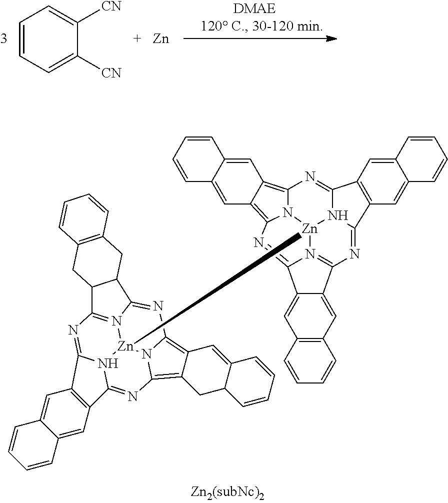

The synthesis of Zn₂(subNc)₂ by using zinc powder and the molecule structure of the new product are illustrated.

The activated powder mixture, comprising approximately 0.64 grams of Zn powder or B, has been mixed with 5.34 grams of Phthalonitrile (PN) in inert gas medium or vacuum conditions for duration of 30-120 minutes in 10-12 ml of dimethylaminoethanol (DMAE) mixture at temperature of 120° C. The reaction mixture has been transformed into dark blue color after approximately 10-15 minutes and it has been observed that the color intensity has increased as the reaction continues. When a more rapid reaction and transformation to the stable final product are desired, the reaction mixture has been heated at temperature of 120° C. for 0.5-2 hours. The mixture cooled down to the room temperature has been respectively washed with substantial amount of hexane and diethylether in a stepped manner, and the impurities are eliminated. The unresolved residue has been resolved in 40-50 ml of methanol, and it has been waited in a cold medium for 24 hours. Afterwards, the dmae₂-Zn₂(subNc)₂ product existing in the solution has been filtered and eliminated. The purple-pink methanol solution has been evaporated by means of the evaporator until dryness is obtained. The pure product obtained has been separated and has been dried for 1 hour at 50-100° C. Preferably, the chloroform solution of the raw reaction product has been passed through silica-gel (SiO₂) column, and it has been purified. Preferably, alumina (Al₂O₃) column has been used.

In FIG. 32, UV-vis spectrums of Zn₂(subNc)₂ compound which are taken in (0.21-0.83)×10⁻⁴ M THF are illustrated and in FIG. 33, the UV-vis spectrums of Zn₂(subNc)₂ compound which are taken in THF/CH₃COOH in proportion of 50:1 in the concentration range of (0.21-0.83)×10⁻⁴ M are illustrated.

In FIG. 34, the FTIR spectrum of Zn₂(subNc)₂ compound is illustrated.

In FIG. 35, the Raman spectrum of Zn₂(subNc)₂ compound is illustrated. The peaks determined in Raman spectrum, taken for characterizing the Zn—Zn bound of the subphtalocyanine compound, having dimeric structure in Zn₂subNc₂ structure, support the structure. The peaks detected in this spectrum are determined to be 1506, 1424, 1396, 1361, 1215, 1187, 1147, 1122, 752, 737, 678, 615, 528, 290, 188 ve 166 cm⁻¹ respectively. These peaks are observed in the graphic given in the figure.

In FIG. 36, the fluorescence spectrum of THF solution excited at 620 nm for the Zn₂(subNc)₂ compound is illustrated, and in FIG. 37, the fluorescence spectrum of Zn₂(subNc)₂ compound THF/CH₃COOH by means of excitation in 531 nm is illustrated.

In FIG. 38, the electrochemical current-voltage (CV) curve of the Zn₂(subNc)₂ compound is illustrated.

In FIGS. 39 and 40, ESI-MS mass spectrum of the dmae₂-Zn₂(subPc)₂ compound is illustrated. The peaks occurring as m/e proportion of [Zn₂(subNc)₂] compound in MS-MS mass spectrum have been interpreted by taking into consideration the molecule formula. In the spectrum, the peak occurring at m/e: 2117.2 is molecular ion peak, and it has been calculated as [M+H₂O+1]⁺ for the closed formula of C₇₂H₃₈N₁₂Zn₂. The mass peak recorded as 1110 has been calculated as [(M−2Zn)+H₂O+Na−1]⁺. In the spectrum, the peak recorded at m/e: 619 has been detected to belong to the Zn-subNc segment of the molecule by means of breaking of the Zn—Zn bound in the molecule, and the fragment has been calculated as [M/2+H₂O+1]⁺ for the closed formula of C₃₆H₁₉N₆Zn. The m/e: 598 peak detected in another spectrum has been calculated as [M/2−1]⁺.

### Example 5

### The Synthesis of CH₃COO—Zn₂(subPc)₂.Dmae

It has been synthesized as a result of mixing the compounds, which have the mole proportions mentioned by the reaction below, in the related solution medium at temperature range between 0 and 100° C. and as a result of waiting between 6 and 240 hours.

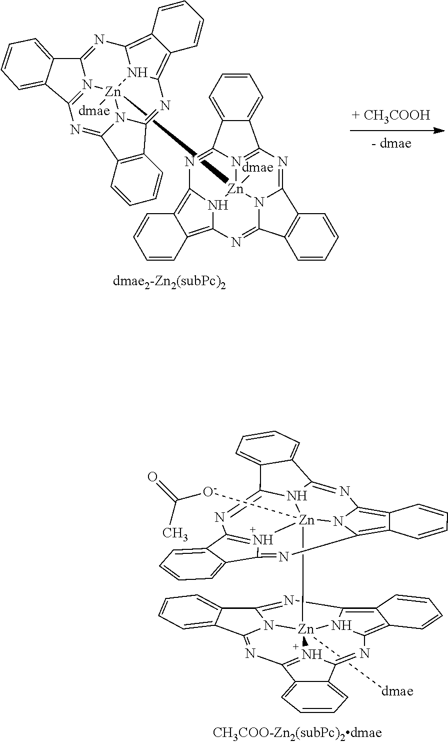

The synthesis of CH₃COO—Zn₂(subPc)₂.dmae and the molecule structure of the new product formed are given above.

In FIG. 41, the UV-vis spectrums of CH₃COO—Zn₂(subPc)₂.dmae compound in (0.24-0.98)×10⁻⁴ M concentration range in CHCl₃/CH₃COOH at a proportion of 50:1 are illustrated, and in FIG. 42, the UV-vis spectrums of CH₃COO—Zn₂(subPc)₂.dmae compound in 0.98×10⁻⁴ M concentration range in THF/CH₃COOH at a proportion of 50:1 are illustrated.

Excitation has been made at wavelength of 423 nm in the fluorescence spectrum of the compound having cationic subphtalocyanine ring structure obtained by waiting the compound for long time under acidic conditions, and high emission bands have been obtained having two maximum at 475 nm and 510 nm (FIG. 43). The Stokes shifts of these bands have been detected to be 52 nm and 87 nm.

### Example 6

### The Synthesis of CF₃COO—Zn₂(subPc)₂.Dmae

It has been synthesized as a result of mixing the compounds, which have the mole proportions mentioned by the reaction below, in the related solution medium at temperature range between 0 and 100° C. and as a result of waiting between 6 and 240 hours.

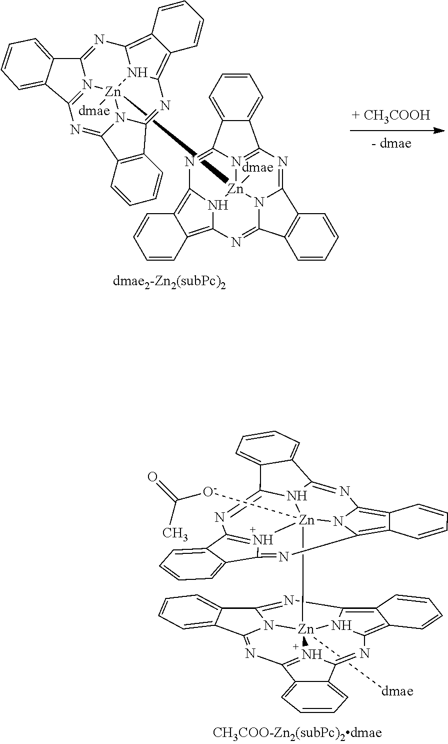

The synthesis of CF₃COO—Zn₂(subPc)₂.dmae and the molecule structure of the new product formed are given above.

In FIG. 44, Maldi-Tof-MS mass spectrum of CF₃COO—Zn₂(subPc)₂.dmae is illustrated.

In the MS spectrum of the CF₃COO—Zn₂subPc₂.dmae having cationic structure having fluorescence characteristic where proton is applied, the peak occurring at m/e: 1116 is in the form of [M+H₂O+1]⁺ for the closed formula of C₅₄H₃₈F₃N₁₃O₄Zn₂ which is theoretically calculated. The peaks having low m/e value occurring in the spectrum have been calculated as [M+H₂O+1]⁺⁺ for the ZnsPc.dmae fragment for m/e: 558.

### Example 7

### The Synthesis of CH₃COO—Zn₂(subNc)₂.Dmae

It has been synthesized as a result of mixing the compounds, which have the mole proportions mentioned by the reaction below, in the related solution medium at temperature range between 0 and 100° C. and as a result of waiting between 6 and 240 hours.

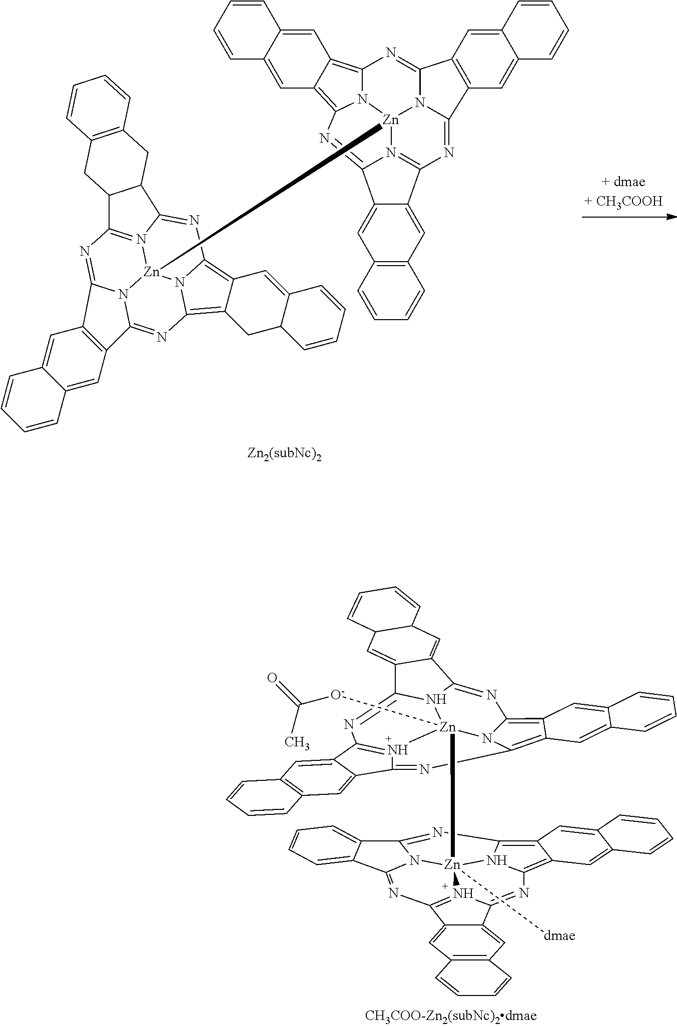

The synthesis of CH₃COO—Zn₂(subNc)₂.dmae and the molecule structure of the new product formed are given above.

In FIG. 45, the UV-vis spectrum of THF/CH₃COOH solution for CF₃COO—Zn₂(subPc)₂.dmae is illustrated.

In FIG. 46, the raman spectrum of CF₃COO—Zn₂(subPc)₂.dmae is illustrated.

### Example 8

### The Synthesis of CF₃COO—Zn₂(subNc)₂.Dmae

It has been synthesized as a result of mixing the compounds, having the mole proportions mentioned by the reaction below, in the related solution medium at temperature range between 0 and 100° C. and as a result of waiting between 6 and 240 hours.

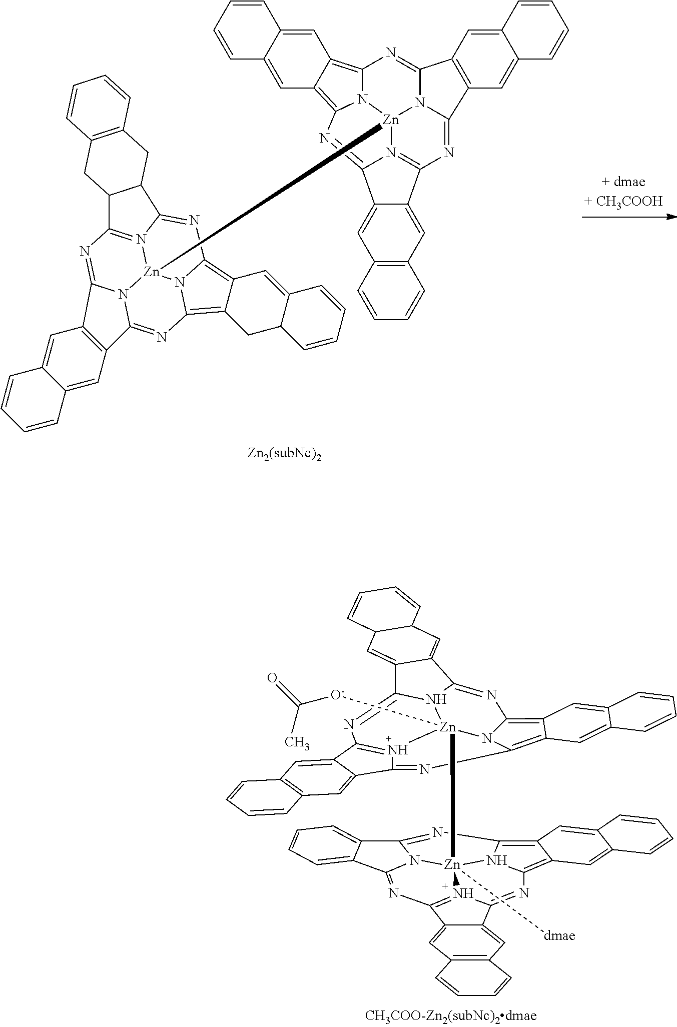

The synthesis of CF₃COO—Zn₂(subNc)₂.dmae and the molecule structure of the new product formed are given above.

### Example 9

### The Synthesis of Pz by Using Metal Powder

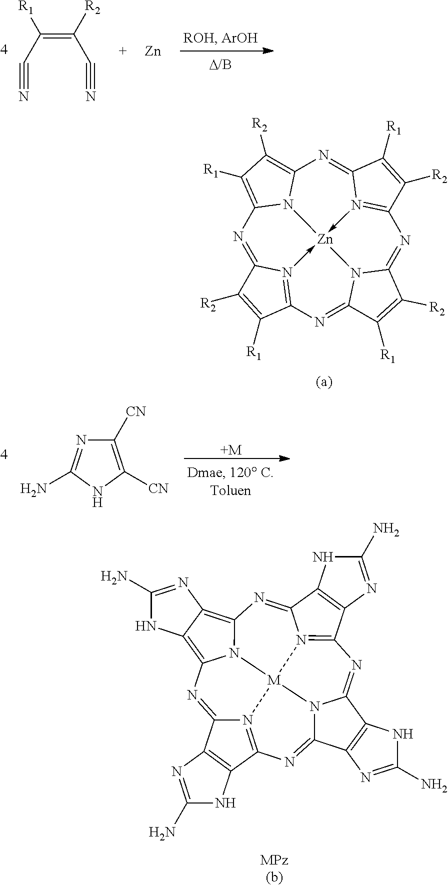

The synthesis of MPz type dye compounds, comprising metal and aminoimidazole ring, from metal powders, and the molecule structure thereof are given above.

### Example 10

### The Synthesis of subPz by Using Metal Powder

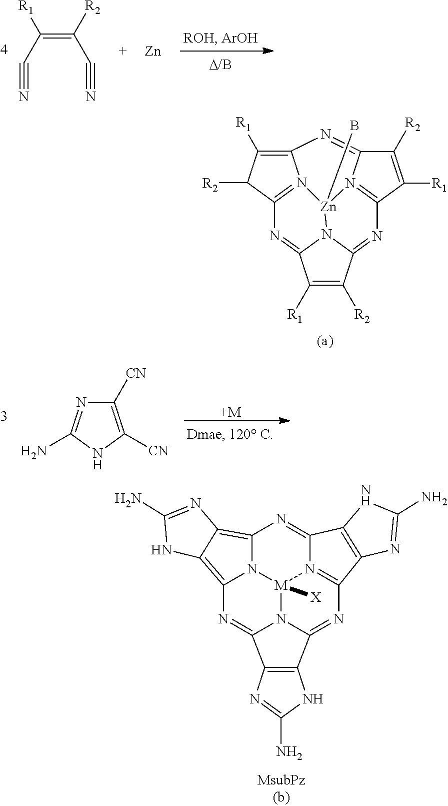

The synthesis of MsubPz type dye compounds, comprising metal and aminoimidazole ring, from metal powders, and the molecule structure thereof are given above.

In FIG. 47, the UV-vis spectrum of ZnsubPz type dye comprising Zn metal and aminoimidazole ring is illustrated.

In FIG. 48, the FT-IR spectrum of ZnsubPz type dye comprising Zn metal and aminoimidazole ring is illustrated.

In FIG. 49, the UV-vis spectrum of TisubPz type dye comprising Ti metal and aminoimidazole ring is illustrated.

In FIG. 50, the FTIR spectrum of the TisubPz type dye comprising Ti metal and aminoimidazole ring is illustrated.

In FIG. 51, the UV-vis spectrum of MgsubPz type dye comprising Mg metal and aminoimidazole ring is illustrated.

In FIG. 52, the FTIR spectrum of MgsubPz type dye comprising Mg metal and aminoimidazole ring is illustrated.

In FIG. 53, the UV-vis spectrum of AlsubPz type dye comprising Al metal and aminoimidazole ring is illustrated.

In FIG. 54, the FTIR spectrum of AlsubPz type dye comprising Al metal and aminoimidazole ring is illustrated.

### Example 11

### The Synthesis of Metal Porphyrine (MPr) by Using Metal Powder

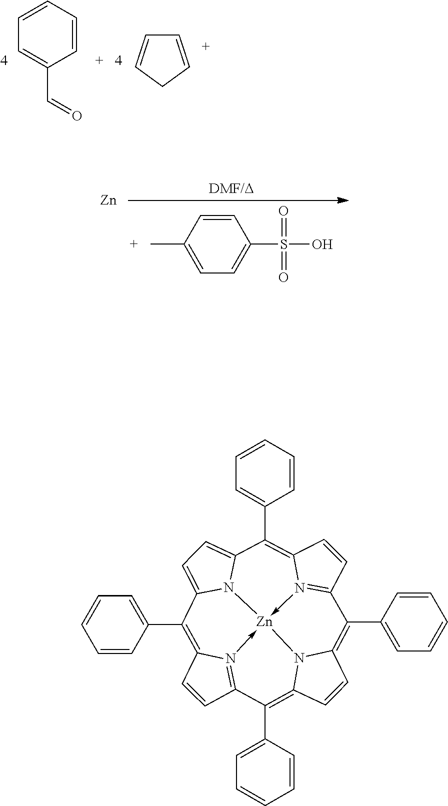

The synthesis of (MPr) type ZnPr dye compounds, comprising metal, from metal powders, and the molecule structure thereof are given above.

### Example 12

### The Synthesis of Metal Sub-Porphyrine (X-MsubPr) by Using Metal Powder

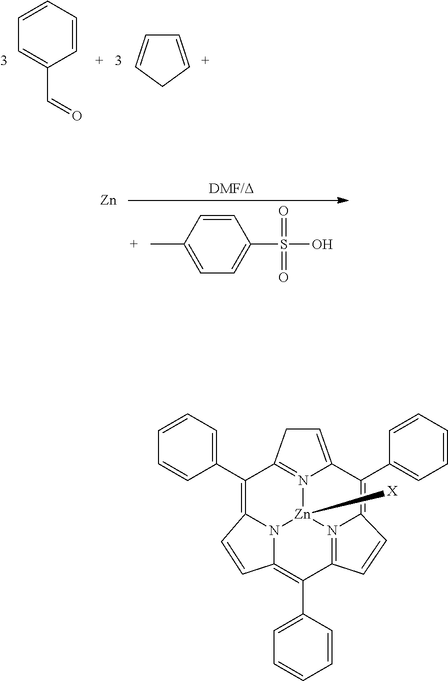

The synthesis of sub-porphyrine (X-MsubPr) type dye compounds, comprising metal, from metal powders, and the molecule structure thereof are given above.

In FIG. 57, the UV-vis spectrums for the dye with type ZnsubPr, comprising Zn metal, are illustrated.

The organic dye, defined by Formula (I), has been given by the following general formula. Here, R, R1-R12 and M and X illustrate the atom and molecule groups selected independently from each other. R, R1-R12 groups are aliphatic or aromatic rings which are welded or adjacent from any R and from any R1 to R12, and H, straight, branched or cyclic alkyl, halide, thioalkyl, thioaryl, arylsulfonyl, alkyl sulfonyl, amino, alkyl amino, aryl amino, hydroxy, alcoxy, acyl amino, acyloxy, phenyl, carboxy, carboxoamido, carboalcoxo, acyl, sulfonyl, cyano and nitro; such that these rings comprise one or more atoms except carbon. Here, M is metals defined by predefined M1. X is anionic organic or inorganic groups.

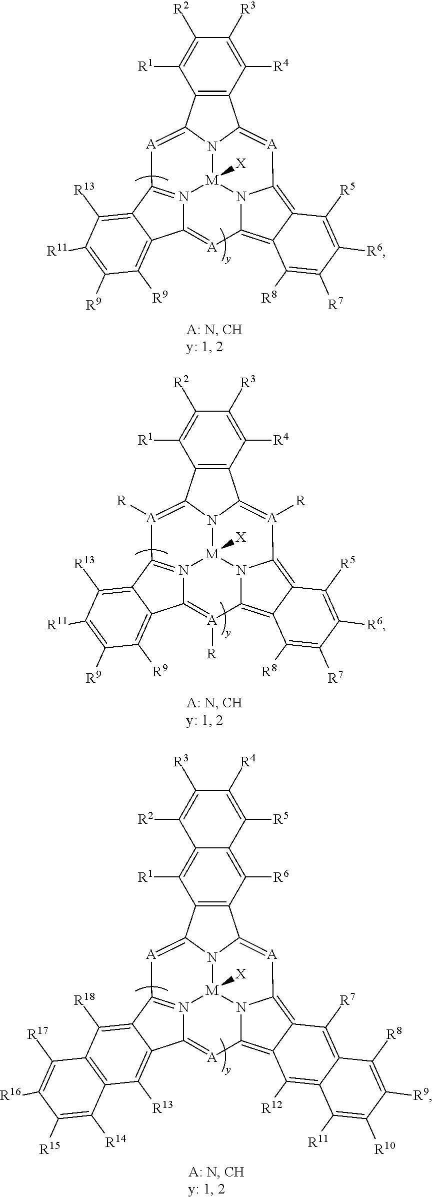

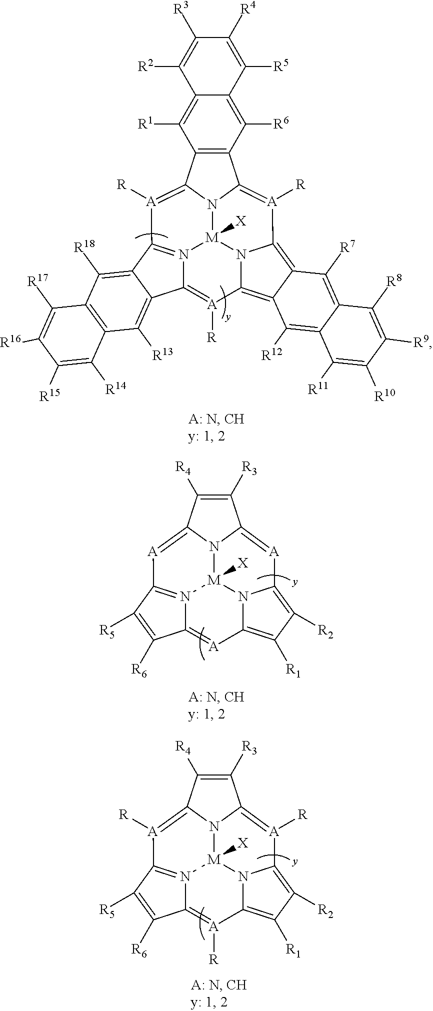

1.-21. (canceled)

22. Aromatic macrocyclic metal complex having one of the following Formula (I) 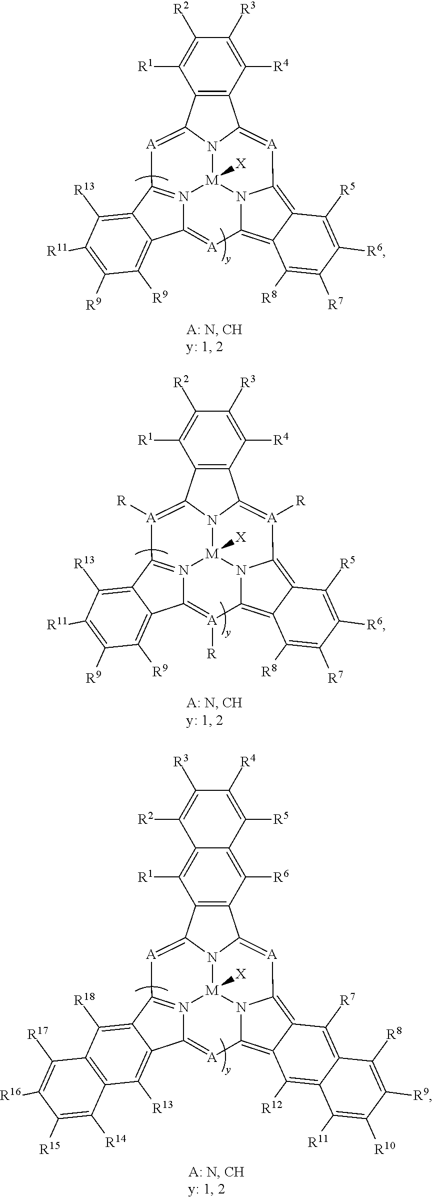 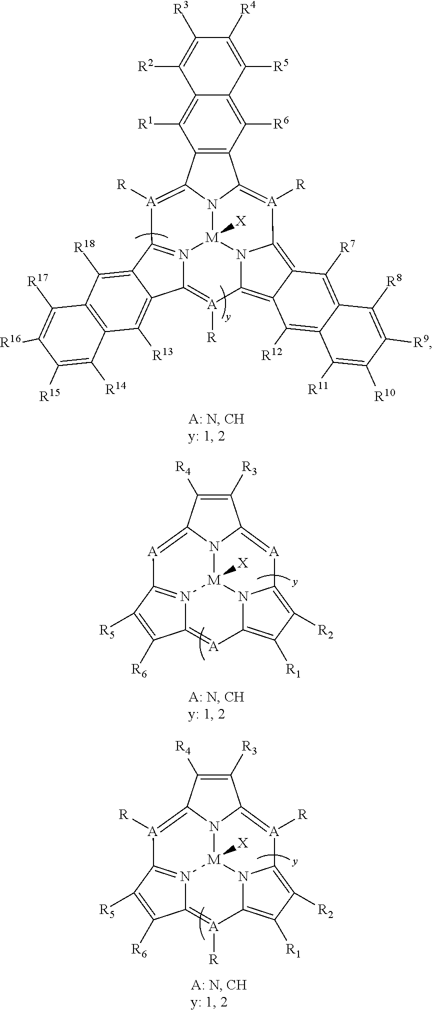
wherein the aromatic macrocyclic compound is selected from a group comprising sub-Phtalocyanine (subPc), sub-Naphtalocyanine (subNc), sub-Porphyrazine (subPz), sub-Porphyrine (Pr), diethanolamine-BsubPc, diethanolamine-BsubNc with or without various R, R₁-R₁₂ and X groups and the metal (M) is selected from a group comprising Li, Na, K, Mg, Ca, Sr, Ba, Ti, Zr, V, Cr, Mo, Mn, Re, Fe, Ru, Co, Rh, Ir, Ni, Pd, Pt, Cu, Ag, Au, Zn, Cd, Al, Ga, In, Si, Ge, Sn, Pb, Sb, Bi, Se, Te elements; R, R₁-R₁₂ and X is an atom and molecule groups selected independently from each other; R, R₁-R₁₂ groups are aliphatic or aromatic rings which are welded or adjacent from any R and from any R₁ to R₁₂, and H, straight, branched or cyclic alkyl, halide, thioalkyl, thioaryl, arylsulfonyl, alkyl sulfonyl, amino, alkyl amino, aryl amino, hydroxy, alcoxy, acyl amino, acyloxy, phenyl, carboxy, carboxoamido, carboalcoxo, acyl, sulfonyl, cyano and nitro; such that these rings comprise one or more atoms except carbon; X is anionic organic or inorganic groups.

23. An aromatic macrocyclic metal complex according to claim 22, characterized in that said aromatic macrocyclic metal complex is one of the following complexes;
2-amino-4,5-dicyano-1H-imidazole and/or N,N′-dimethylaminoethanol-ZnsubPz;
2-amino-4,5-dicyano-1H-imidazole and/or N,N′-dimethylaminoethanol-TisubPz;
2-amino-4,5-dicyano-1H-imidazole and/or N,N′-dimethylaminoethanol-MgsubPz;
2-amino-4,5-dicyano-1H-imidazole and/or N,N′-dimethylaminoethanol-AlsubPz.

24. Dimers of aromatic macrocyclic metal complexes according to claim 22.

25. A dimer aromatic macrocyclic metal complex according to claim 24, characterized in that it is dmae₂-Zn₂(subPc)₂ where dmae is N,N′-dimethylaminoethanol.

26. An aromatic macrocyclic metal complex according to claim 22, characterized in that it is Zn₂(subNc)₂.

27. Acid salts of an aromatic macrocyclic metal sub-phtalocyanine complex and the dimer thereof according to claim 22, characterized in that they are acetic acid or trifluoroacetic acid and other organic carbocyclic acid or sulfonic acid or formic acid, propionic acid, butyric acid, lactic acid, citric acid, p-toluene sulfonic acid, succinic acid, salicylic acid, benzoic acid or their derivatives.

28. A dimer metal phtalocyanine complex according to claim 27, characterized in that the dimer metal phtalocyanine complex is one of following complexes
CH₃COO—Zn₂(subPc)₂.N,N′-dimethylaminoethanol
CF₃COO—Zn₂(subPc)₂.dmae or (CF₃COO)₂—Zn₂(subPc)₂ where dmae is N,N′-dimethylaminoethanol
CH₃COO—Zn₂(subNc)₂.dmae or (CH₃COO)₂—Zn₂(subNc)₂, where dmae is N,N′-dimethylaminoethanol
CF₃COO—Zn₂(subNc)₂.dmae or (CF₃COO)₂—Zn₂(subNc)₂, where dmae is N,N′-dimethylaminoethanol.

29. A method or synthesis of Formula (I) and a dimer of Formula (I) according to claim 22, characterized in that; including a following steps;
a. The metal, nano metal or its solid powder mixture is placed in a reaction vessel;
b. The precursor compounds are added to the reaction vessel;
c. Dimethyaminoethanol, diethanol amine or another base is added to the mixture;
d. The reaction vessel is sealed, evacuated or preferably purged with inert N₂ or Ar before the reaction;
e. The mixture is heated up to between 40-350 C, under continuous stirring for 0-48 hours
f. After the reaction, the vessel is cooled dawn to the room temperature to collect the colored raw dye material
g. The collected raw dye powder are purified to separate the subphthalocyanine dyes from the phthalocyanines and the other impurities;
and characterized in that nano metal powder is used.

30. Usage of Formula (I) compounds and the dimers of Formula (I) compounds as dye according to claim 22 or 24.

31. A synthesis method according to claim 29, characterized in that solvent is selected from mono alcohols with high molecular weight, mono alcohols with low molecular weight, poly alcohols with high molecular weight, poly alcohols with low molecular weight, polyethylene glycols with low and high molecular weight, alkyl amines, mono ethanol amine, substituted mono ethanol amines, N,N-dimethyl ethanol amine (DMAE), diethanol amine (DEA), triethanol amine, ethylene diamine, substituted ethylene diamines, polyethylene amines, morpholine, piperazine, N-methyl prolidone, pyridine, substituted pyridines, N alkyl and N,N dialkyl amine substituted pyridines, the substances comprising pyrimidine rings, quinoline, urea, substituted urea, dimethyl urea, tetramethyl urea, aniline, substituted anilines, acetamide, substituted acetamides, formamide, substituted formamides and water, and in addition to these; toluene, xylene, cumene, benzene, naphthalene, chlorobenzene, dichlorobenzene, chloroform, acetone, ethyl methyl ketone, methanol, ethanol, isopropanol, butanol, acetonitrile, ethyl acetate, dimethylformamide, dimethylsulphoxide, tetrahydrofuran are used in the reactions.

32. A method for synthesis of Formula (I) and a dimer of Formula (I) compounds according to claim 29, characterized in that metal catalyst (M) is selected from Li, Na, K, Mg, Ca, Sr, Ba, Ti, Zr, V, Cr, Mo, Mn, Re, Fe, Ru, Co, Rh, Ir, Ni, Pd, Pt, Cu, Ag, Au, Zn, Cd, B, Al, Ga, In, Si, Ge, Sn, Pb, Sb, Bi, Se, Te; metal oxide carrier catalysts (MO) used are selected from Al₂O₃, ZnO, TiO₂, SiO₂, MgO, B₂O₃, Zeolite and Hydroxyapatite; and as MX catalysts, X is selected from F, Cl, Br, I, CH₃COO—, SO₄²—, C₂O₄²⁻, PO₄³⁻, NO₃⁻, OH⁻, CO₃²⁻, HCO₃⁻, H₂PO₄⁻, HPO₄²⁻.

33. A method for synthesis of Formula (I) and a dimer of Formula (I) compounds according to claim 29, characterized in that the groups, provided at the center of the subPc and subNc's and subPz and subPr's and bound axially to metal are R—OH, R—NH₂, R—SH, R—COOH, R—SO₃H, R—B(OH)₂, Ar—OH, Ar—NH₂, Ar—SH, Ar—COOH, Ar—B(OH)₂, Ar—SO₃H, H₂O, F⁻, Cl⁻, Br⁻, I⁻, CN⁻, NO₃⁻, H₃BO₃, H₃PO₄ and the different derivatives of them.
